(19) United States
(12) Patent Application Publication
(10) Pub. No.: US 2022/0266408 A1
(43) Pub. Date: Aug. 25, 2022

(54) MACHINE AND A METHOD FOR PROCESSING LATERAL EDGES OF GLASS PLATES, PLATES OF STONE MATERIAL OR PLATES OF SYNTHETIC MATERIAL

(71) Applicant: BIESSE S.p.A., Chiusa di Ginestreto (Pesaro) (IT)

(72) Inventor: Roberto SELCI, Chiusa di Ginestreto (Pesaro) (IT)

(73) Assignee: BIESSE S.p.A., Chiusa di Ginestreto (Pesaro) (IT)

(21) Appl. No.: 17/652,352

(22) Filed: Feb. 24, 2022

(30) Foreign Application Priority Data
Feb. 25, 2021 (IT) 102021000004472

(51) Int. Cl. B24B 9/10; B65G 49/06; C03B 33/03; B24B 9/00

(52) U.S. Cl. CPC B24B 9/102; B65G 49/061; C03B 33/03; B24B 9/002

(57) ABSTRACT

In a machine and in a method for processing lateral edges of glass plates, plates of stone material, and plates of synthetic material, there is a group of gripping members of the plate configured to hold a plate in a horizontal position. The plate is caused to advance in a conveying longitudinal direction, in such a way as to bring a lateral edge of the plate to engage in succession an aligned series of grinding tools forming part of a stationary machining unit. In one example, the group of gripping members of the plate is rotatably carried around a vertical axis by a carriage, which is movable in the conveying longitudinal direction and in a transverse direction orthogonal to the longitudinal direction. The gripping members are carried by the carriage in such a way as to be adjustable in position, by means of electronically-controlled actuator devices, with respect to the carriage and relative to each other.

### FIELD OF THE INVENTION

The present invention relates to machines and methods for processing (in particular for grinding), edges of glass plates, plates of stone material or plates of synthetic material.

### PRIOR ART

In the field of machines for grinding lateral edges of plates, a first category of machines called “bilateral machines” is known, in which the glass plate to be machined is arranged horizontally, and advances between two stationary lateral benches carrying aligned series of grinding tools, which sequentially engage two opposite lateral edges of the plate as it advances. Machines of this type may comprise a first section oriented in a first direction, for processing two opposite edges of the plate, and a second section arranged at 90° with respect to the first section of the machine, also having two lateral benches of grinding tool. After the plate reaches the end of the first section of the machine that processes a first pair of opposite edges of the plate, the plate itself is transported in a direction orthogonal to the direction previously followed, to enable processing of the second pair of lateral edges of the plate in the second section of the machine.

In the field of machines for grinding lateral edges of plates, so-called “vertical rectilinear machines” are also known, in which the plate proceeds in a single conveying longitudinal direction, remaining in a substantially vertical plane. Known vertical rectilinear machines have a conformation consisting of a main base where the plate movement system and the units responsible for carrying out the processing action of the plate edge reside. During the grinding process, the plate is supported in a substantially vertical position by a backrest, having an inclination of a few degrees with respect to the vertical plane, so as to allow a stable support of the plate during the whole processing stage. The aforesaid backrest, in addition to being located along the processing station, extends both in the loading area and in the unloading area of the machine, in order to allow the operator to deposit the product to be processed at the entrance of the machine, and to pick up the machined product at the exit of the machine. Vertical machines are equipped with a series of tools arranged in sequence, able to perform the finishing of the edge of a plate in a single processing task, by removing a layer of material whose thickness can be determined by the operator. In these machines, to perform the processing of one or more edges of a plate, even when it has a rectangular geometric shape, it is necessary to perform the processing of only one side of the plate at a time. The operator places the plate on the backrest at the machine entrance, and then moves near the backrest at the machine exit to pick up the plate after processing one edge of the plate, and then brings it back to the machine entrance, rotating the plate into a position suitable for processing another edge of the plate. Known machines of this type do not allow corrections in the geometry of the product (which may be due to imperfections in the previous cutting operations), and only allow processing of each edge of the plate with the typical quality of a grinding, polishing and chamfering operation obtained by means of the set of tools provided in the machine. The operator may adjust the working depth of the tools in the plate and the speed of advancement of the plate, while the rotation speed of the grinding tools is fixed as a rule.

Vertical machines are also known for grinding edges of plates, which provide for the possibility of varying the configuration of the sequence of tools of the machining unit in order to meet different needs of shape and surface quality of the edge to be machined.

A machine according to the preamble of claim 1 is known from document JP 4305376 B2.

Document EP1201612A2 shows a machine for breaking a glass plate along an incision line and for separating the two plate portions obtained thereby, in which movable gripping units are provided, which are engaged on the plate on both sides of the breaking line, after the breaking operation has been performed, and which are then moved to separate the two plate portions from each other.

### Object of the Invention

A first object of the invention is to propose a machine that is capable of grinding the edges of glass plates or plates of stone material or synthetic material, while keeping the plate in a horizontal position, so as to also be able to perform operations of squaring of the product and/or correction of the dimensions based on the nominal project dimensions.

Another object is to provide a horizontal machine of the type indicated above, which is capable of processing the edges of the plate—one after the other—and in which, at least in the case of relatively large plates, the plate must be located in position—with respect to the unit of machining tools—only at the beginning of the cycle after loading the plate onto the machine, without having to repeat this operation each time that a new lateral edge of the plate has to be machined.

Another object of the invention is that of producing a machine of the type indicated above in which the plate can be loaded and unloaded either in a totally automatic manner, or manually.

Another object of the invention is that of producing a machine of the type indicated above in which the entire cycle of processing the different edges of the plate, including the repositioning operations of the plate that are necessary each time it is required to proceed with the processing of a new edge of the plate, can be performed fully automatically.

Another object of the invention is to provide a machine of the type indicated above, which is equipped with a group of plate gripping members for gripping the plate to be processed, which is arranged so as to be automatically reconfigurable as a function of the shape and size of the plate to be gripped.

Another object of the invention is to provide a machine of the type indicated above in which it is—in any case—possible to reposition the plate for processing a new edge of the plate even with manual operations.

Another object of the invention is to provide a machine of the type indicated above in which the plate machining unit may include both a series of grinding tools intended to carry out a sequence of grinding operations on the edges of the plate, and devices for carrying out auxiliary processes, such as devices for making chamfers or curved profiles at the corners of the plate.

Yet another object of the invention is to provide a machine of the type indicated above which can be used both as a stand-alone machine and as a machine forming part of a production line including additional machines upstream and/or downstream of the machine according to the invention, to carry out an entire processing cycle of the plate.

### SUMMARY OF THE INVENTION

In order to achieve one or more of the aforesaid objects, the invention is directed to a machine for processing edges of glass plates, plates of stone material or plates of synthetic material, comprising the characteristics of claim 1.

In a preferred embodiment, the machine according to the invention is also characterized in that the carriage carries the unit of plate gripping members in a rotatable way around a vertical axis, and is provided with an electronically-controlled actuator device for controlling the rotation around said vertical axis,

In such a way that after processing of an edge of a plate, the plate can be brought to a position out of interference with the tools of the stationary machining unit, and can then be rotated around said vertical axis and returned to a starting position with respect to the stationary machining unit, for subsequent processing of another lateral edge of the plate by means of said grinding tools of the stationary machining unit.

Still in the case of the preferred embodiment, the carriage carrying the plate gripping members can also be moved by an electronically-controlled actuator device in a transverse direction, orthogonal to said conveying longitudinal direction, so that after processing of a lateral edge of the plate, the plate can be moved transversely to the conveying longitudinal direction into a position in which it can be rotated around said vertical axis without interfering with said stationary machining unit, after which the plate can be brought back to said starting position to start processing of another edge of the plate.

Again in the case of the preferred embodiment, a conveyor device is associated with the stationary processing unit for advancing a plate along said conveying longitudinal direction in such a way as to bring an edge of the plate to engage the grinding tools of the stationary machining unit, in succession. The device for actuating the longitudinal movement of the carriage carrying the group of plate gripping members is controlled in such a way as to move the carriage in synchronism with the movement imparted to the plate by said conveyor device.

In one example, the conveyor device associated with the machining unit comprises an upper belt conveyor and a lower belt conveyor positioned and configured to receive a plate therebetween, in such a way as to advance it in the conveying longitudinal direction.

According to another preferred characteristic of the invention, the carriage carries the gripping members, individually or in groups, in positions which are adjustable by means of electronically-controlled actuator devices. Preferably, the entire group of gripping members is carried by the carriage in a rotatable way around a vertical axis, and may be oriented around this vertical axis by means of another electronically-controlled actuator device.

According to a another characteristic of the invention, the machine comprises a plate positioning system, to locate the plate in position with respect to the stationary machining unit along the longitudinal direction and along the transverse direction, at the beginning of a processing cycle, before locking the plate onto said group of plate gripping members, which locates it in position with respect to the vertical direction. After processing of a first lateral edge of the plate, the group of gripping members is always kept engaged on the plate until processing of all the lateral edges of the plate that are to be machined has been completed, so that the operation for locating the plate in position does not have to be repeated again.

In one example, this positioning system comprises an abutment element, which can be temporarily positioned in a raised position to engage the front edge of a plate to be processed against it. Furthermore, the positioning system comprises a side wall for supporting the plate, which can be moved by an actuator device transversely with respect to the aforesaid conveying longitudinal direction, to transversely push a plate to be processed up to a predetermined transverse position with respect to the tools of said stationary machining unit, corresponding to a certain working depth of the tools on the plate.

Thanks to the aforesaid characteristics, the machine according to the invention allows a series of important advantages to be obtained: the machine allows positioning of the plate gripping members in a completely automatic way, according to the shape and size of the plate to be processed. The machine gives the possibility to carry out the operations of loading the plate at the machine entrance, and unloading the plate from the machine exit in a completely automatic way. The machine is also suitable for enabling both loading and unloading of the plate at the upstream end of the machine. The machine according to the invention can be equipped with devices to perform chamfers or curved profiles at the corners of the plate. Furthermore, the machine according to the invention may also be used in combination with machines to perform further drilling and milling operations of the plate, arranged upstream and/or downstream of the machine according to the invention. One of the advantages deriving from keeping the plate in a horizontal position consists in the possibility of making the cycle of operations required to reposition the plate completely automatic, after processing one edge of the plate, in order to proceed with the processing of another edge of the plate. A further advantage deriving from the horizontal positioning of the plate consists in the possibility of carrying out squaring operations of the plate and/or operations to bring the plate to the project dimensions. Another advantage consists in the fact that the operations necessary to locate the plate in position with respect to the machining unit must be carried out only at the beginning of the machining cycle, before machining a first edge of the plate, without the need to repeat these operations when processing the remaining edges of the plate. Finally, as already indicated, a significant advantage of the machine according to the invention consists in the fact that the machine can be set up in a completely automatic way, thanks to the fact that the plate gripping members are adjustable in position by means of electronically-controlled actuators, depending on the shape and size of the plate. The aforesaid gripping members may be of any known type, in particular, for example, vacuum cups or gripping clamps.

In a variant, the machine is arranged with two or more carriages carrying respective units of gripping members to carry respective plates to be processed, each carriage being displaceable in the conveying longitudinal direction and in the transverse direction by means of respective electronically-controlled actuator devices.

The invention is also directed at the method that can be implemented with the machine of the invention.

### DETAILED DESCRIPTION OF THE INVENTION

Further characteristics and advantages of the invention will become apparent from the description that follows with reference to the attached drawings, provided purely by way of non-limiting example, wherein:

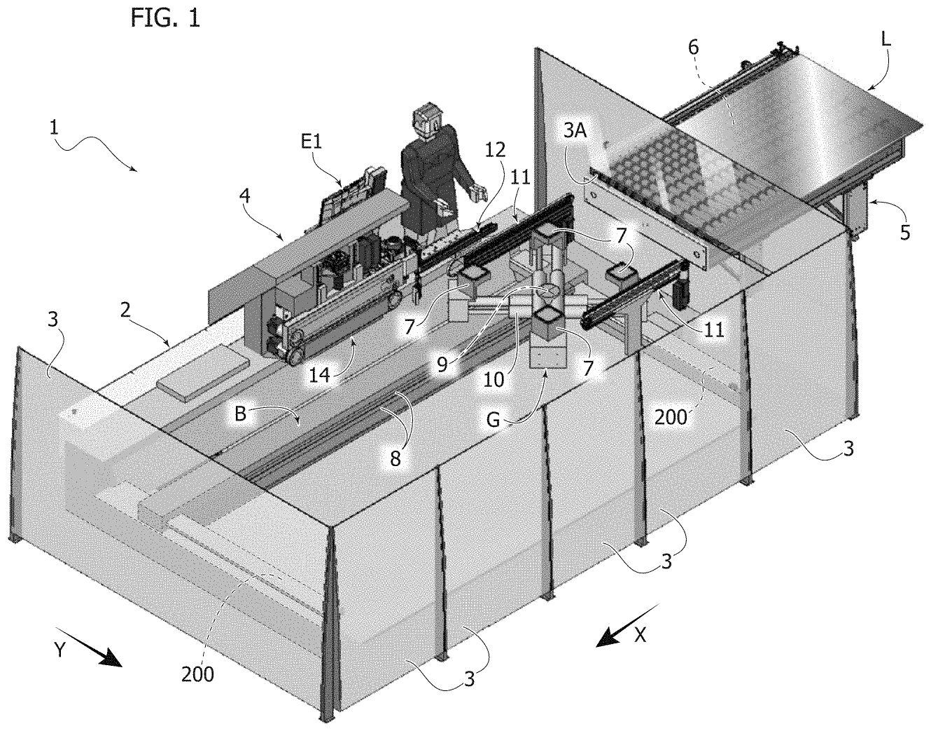

FIG. 1 is a schematic perspective view of an embodiment of the machine according to the invention.

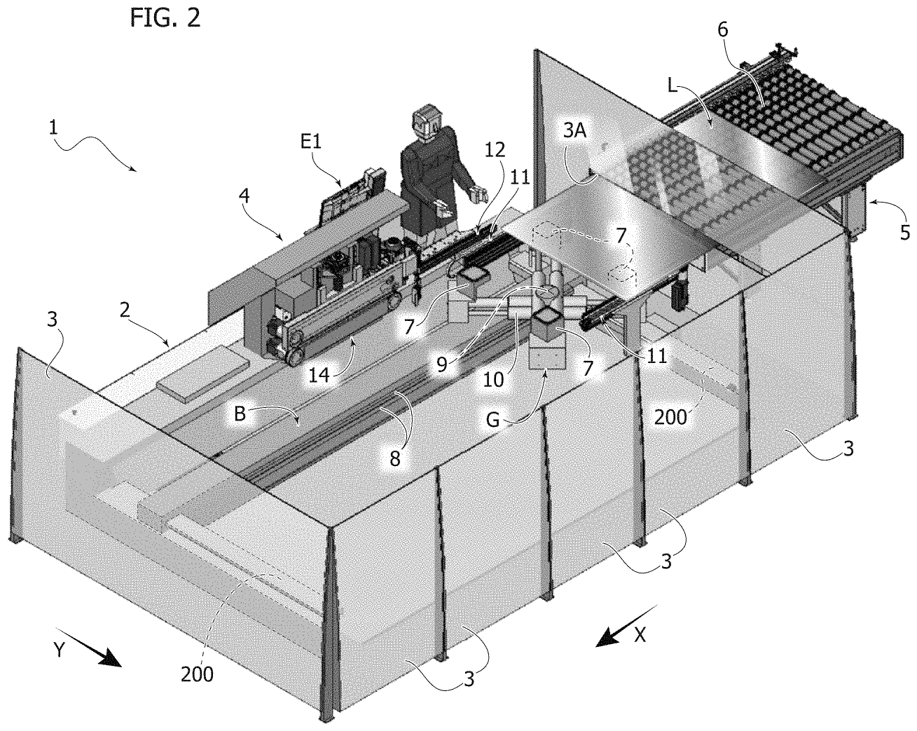

FIGS. 2-7 illustrate successive steps of a processing cycle carried out by means of the machine of FIG. 1.

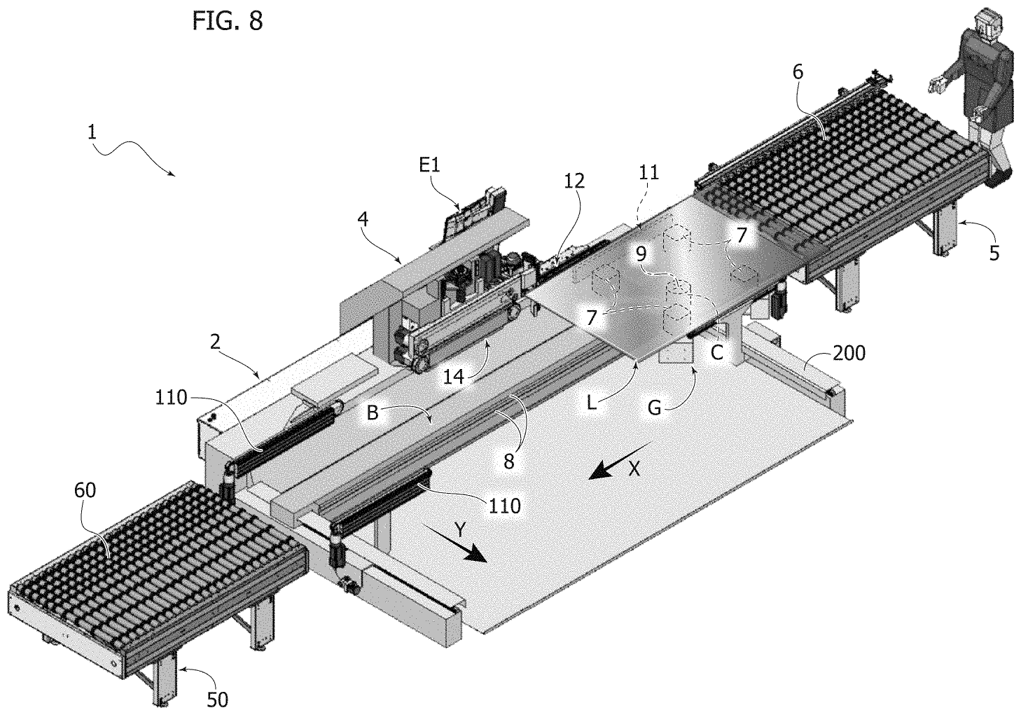

FIG. 8 illustrates an implementation of the machine of FIG. 1 with an inlet upstream of the machine and an unloading area downstream of the machine.

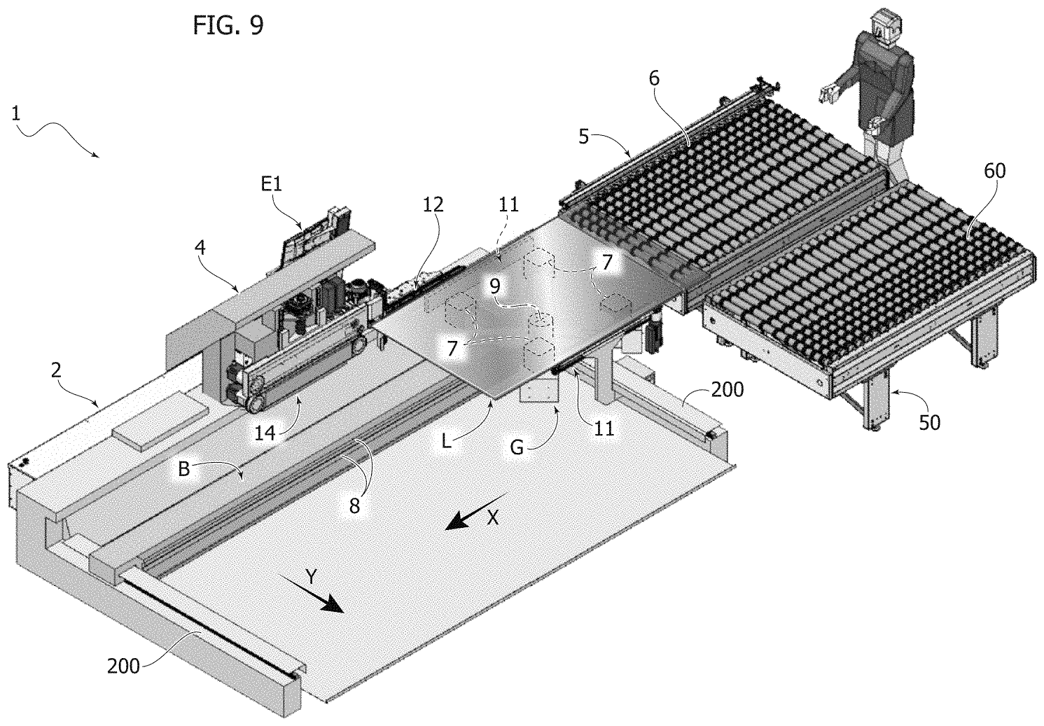

FIG. 9 illustrates a variant with inlet and unloading both arranged upstream of the machine.

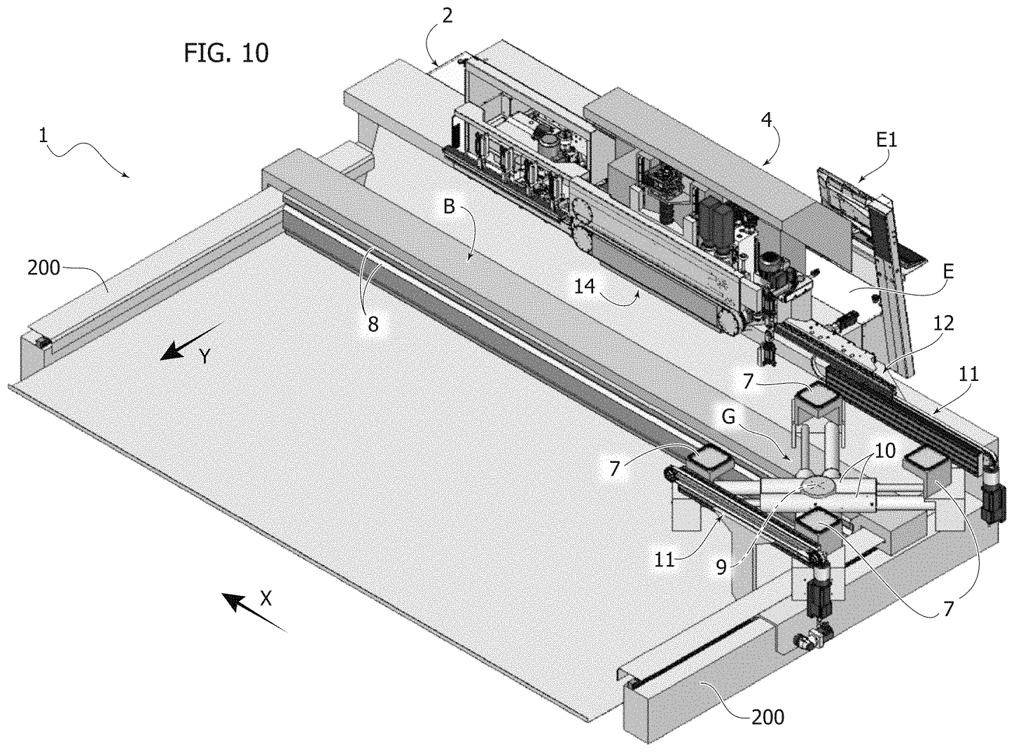

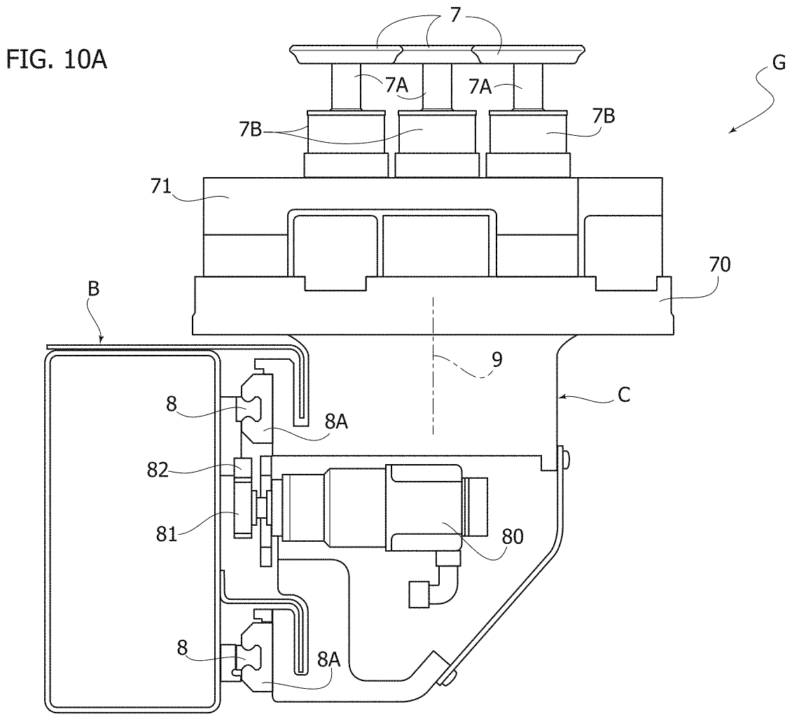

FIG. 10 illustrates a further perspective view of the machine of FIG. 1.

FIG. 10A shows a cross-sectional view on an enlarged scale of the carriage movable in the X direction of the machine, carrying the plate gripping unit.

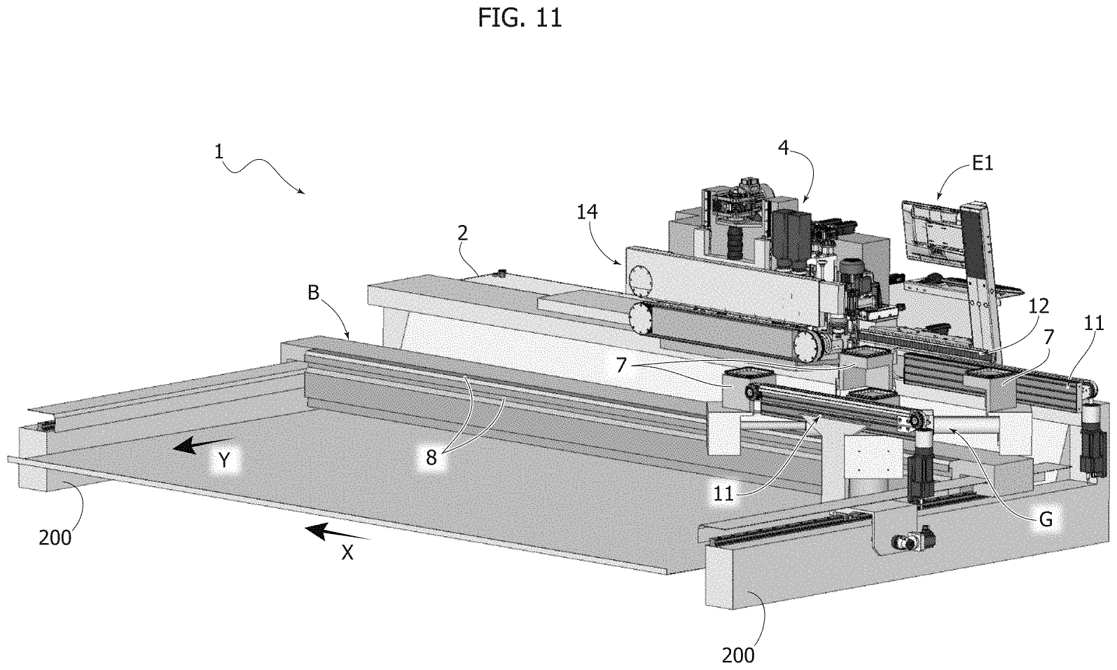

FIG. 11 illustrates a further perspective view of the machine of FIG. 1.

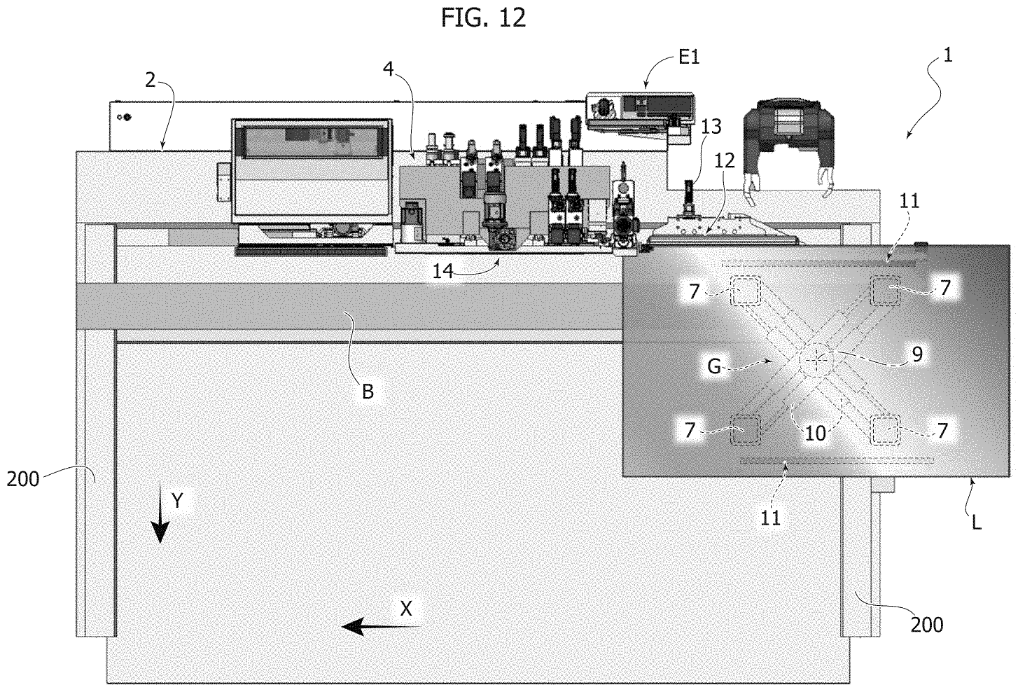

FIG. 12 illustrates a plan view of the machine of FIG. 1.

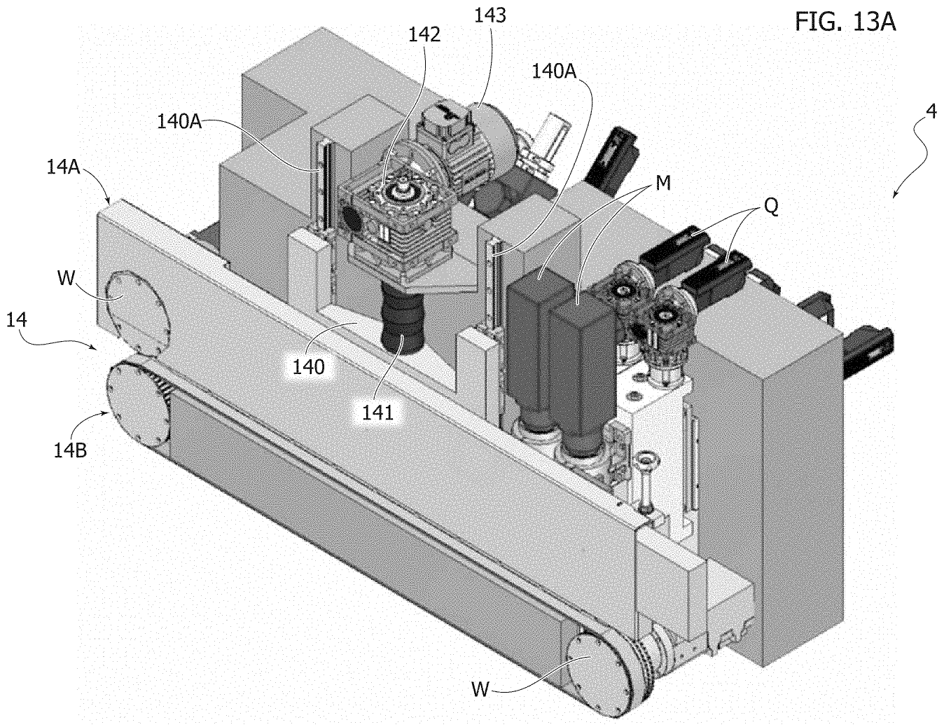

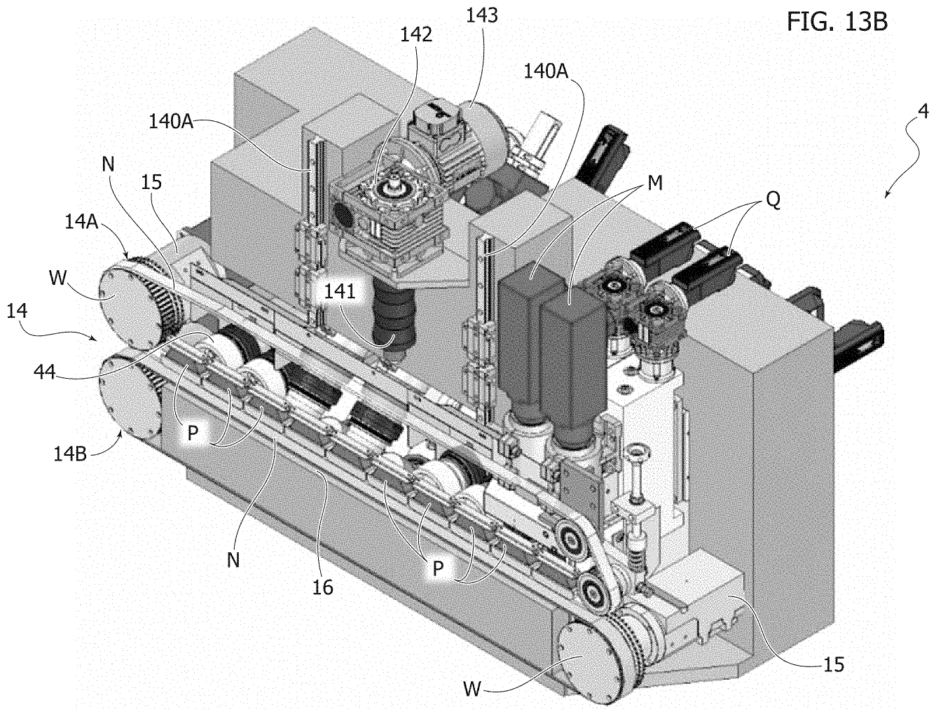

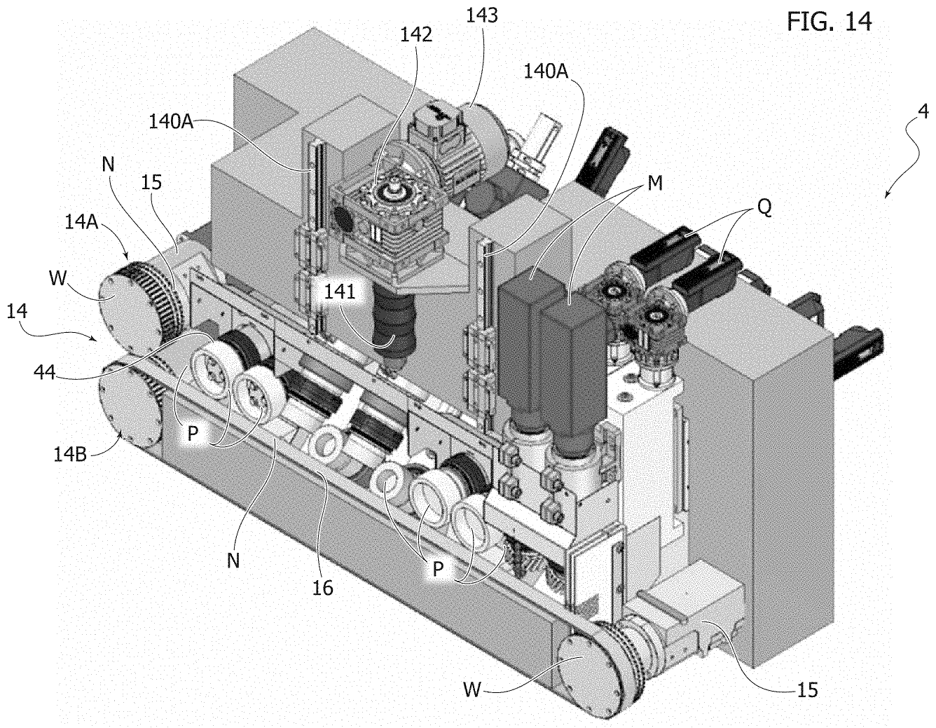

FIGS. 13A, 13B, 14 are perspective views of the machining unit forming part of the machine of FIG. 1.

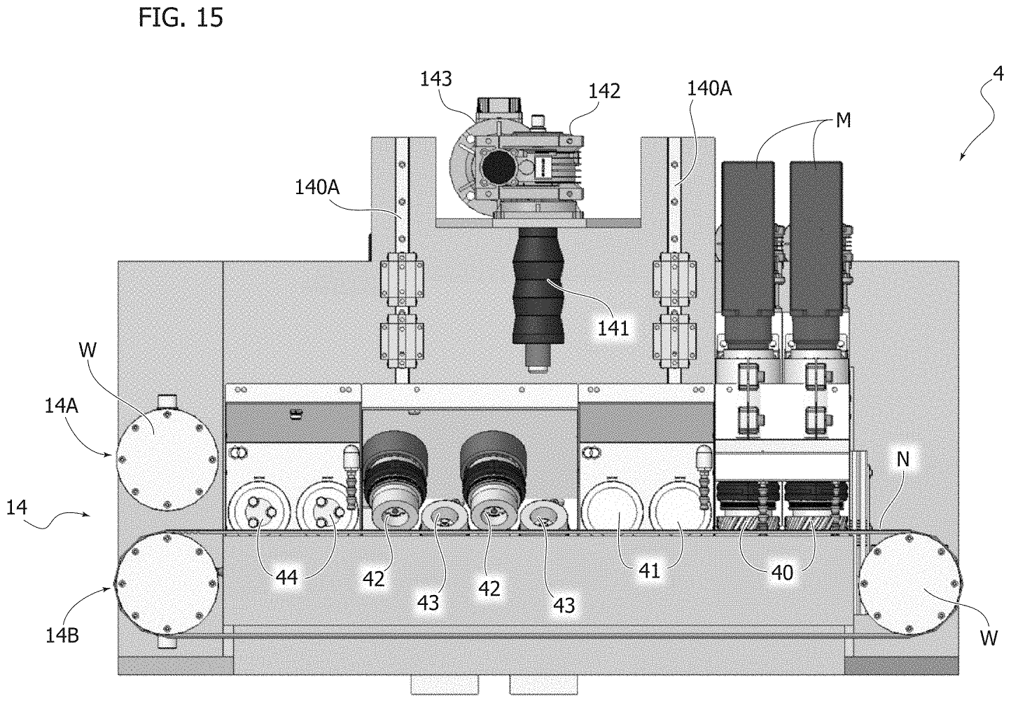

FIGS. 15,16 show a front view and a perspective view of the machining unit of the machine of FIG. 1.

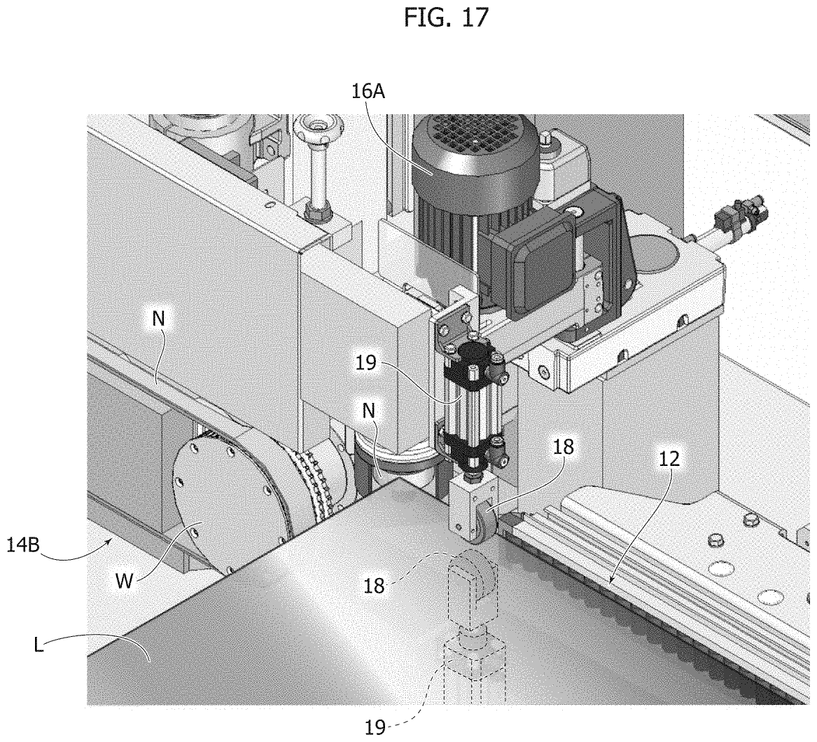

FIG. 17 illustrates a detail of the machine of FIG. 1.

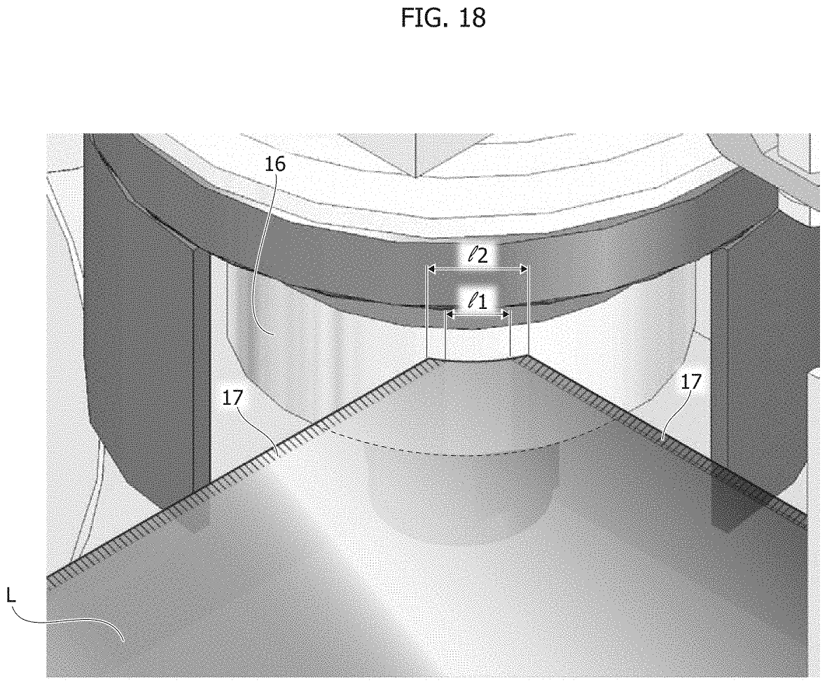

FIG. 18 illustrates a detail of FIG. 17 on an enlarged scale,

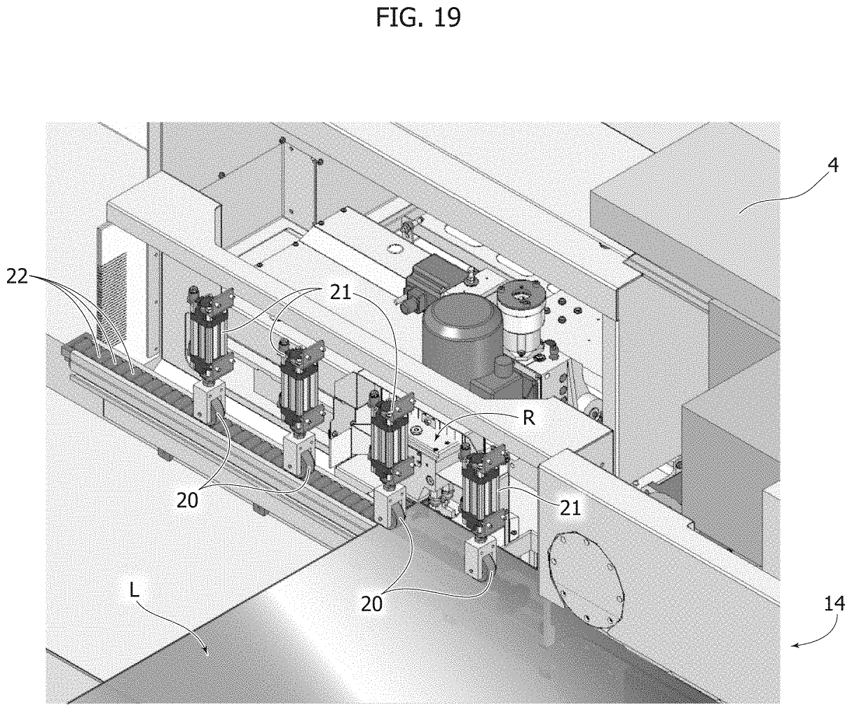

FIG. 19 illustrates an additional detail of the machine of FIG. 1.

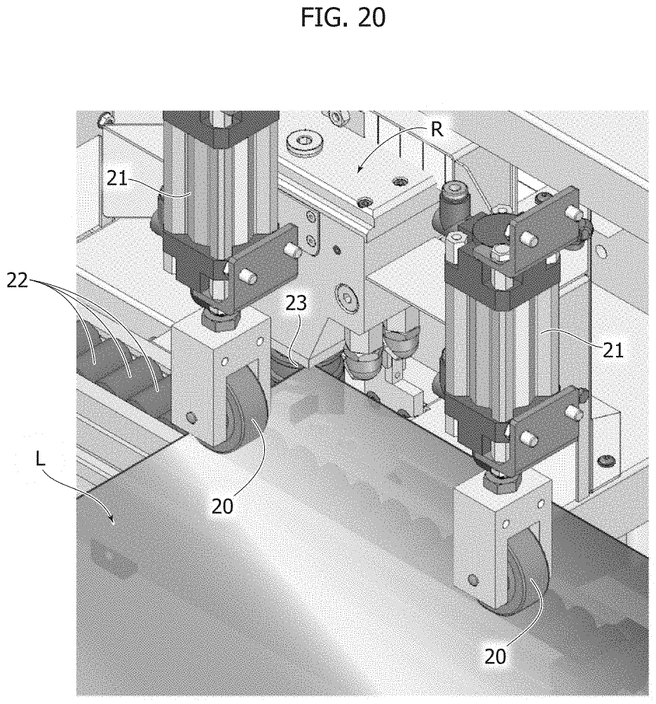

FIG. 20 illustrates a detail of FIG. 19 on an enlarged scale.

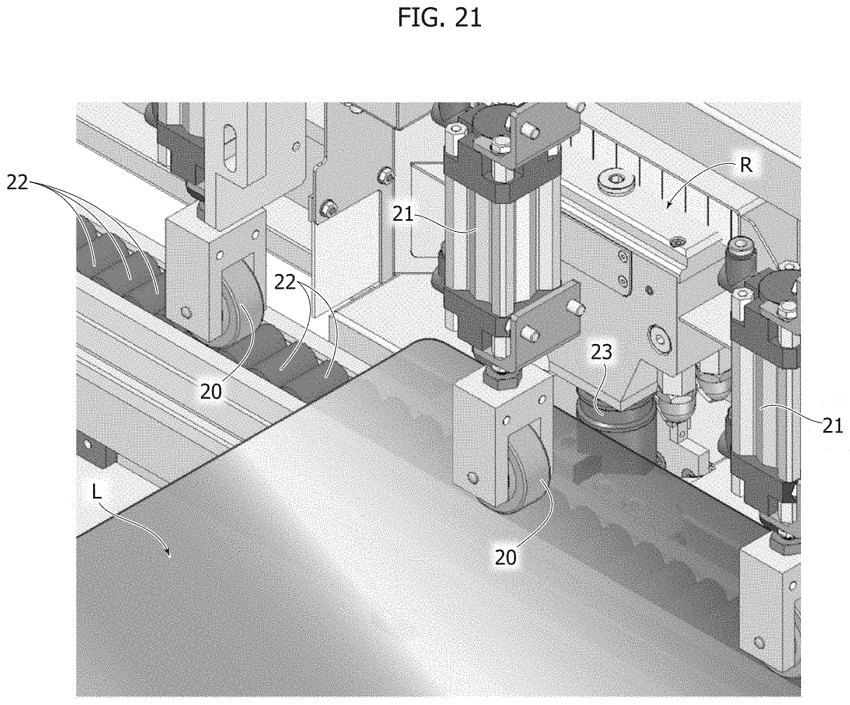

FIG. 21 illustrates the same detail as FIG. 20 at a successive step of its operating cycle,

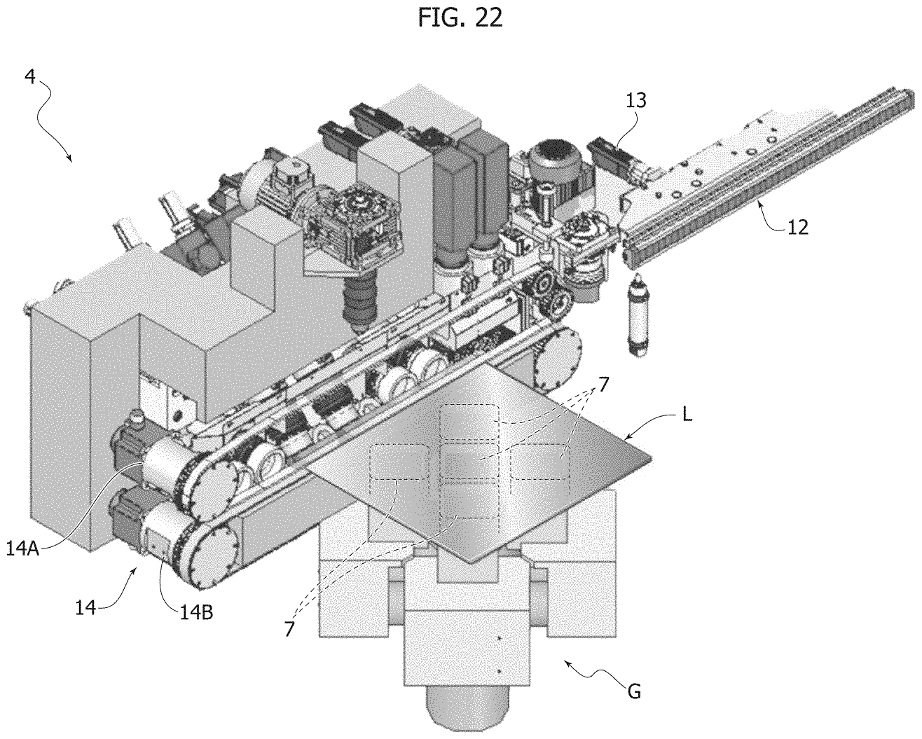

FIGS. 22-28 are perspective views that schematically illustrate the use of the machine of FIG. 1 with glass plates having different shapes and sizes, and

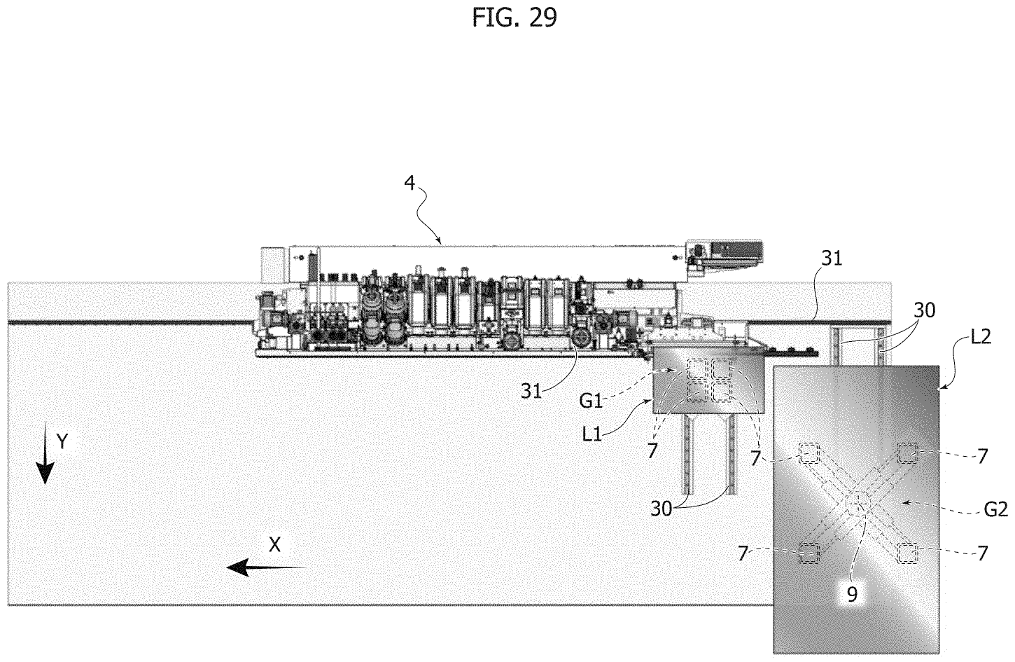

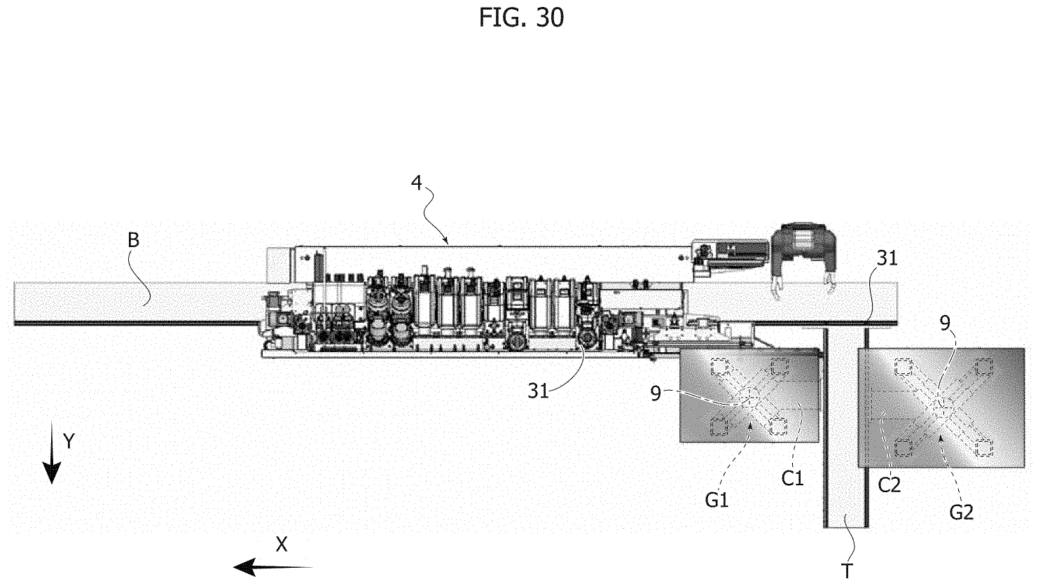

FIGS. 29, 30 are plan views of two variants of the machine according to the invention.

In the drawings, the reference number 1 indicates—in its entirety—a horizontal straight machine for processing, in particular grinding, of the lateral edges of glass plates, stone material plates or synthetic material plates. The machine 1 comprises a stationary structure, indicated—in its entirety—by the reference number 2, defining a work area protected by safety barriers 3.

On one side of the stationary structure 2 there is a stationary machining unit 4, described in detail below, including a series of machining tools, in particular grinding tools (not visible in FIG. 1) aligned along a conveying longitudinal direction X of the plates.

A plate intended to be machined by the unit 4 is made to advance in the X direction, keeping it in a horizontal position, so as to bring a lateral edge of the plate to engage the tools of the unit 4, in succession.

In the example illustrated, upstream of the machine 1 there is a table 5 with a roller surface 6, which receives thereabove a plate L intended to be subjected to a processing cycle in the machine 1. To this end, the wall 3 adjacent to the table 5 has an opening 3A through which the plate L can be introduced into the working area A of the machine 1.

As will also be indicated below, the systems described and illustrated here for loading a plate into the machine and unloading a plate from the machine are provided purely by way of non-limiting example. As it will also be evident from the following, systems can be associated with the machine according to the invention to carry out the loading and/or unloading of the plate in a completely automatic way, as well as it is possible to envisage, in addition to or alternatively, that the loading operations and/or unloading are done manually. As already indicated, the machine according to the invention is suitable for use as a stand-alone machine, or also as a machine forming part of a production line, in which case the plates received by the machine come from a section of the production line upstream of the machine and, after processing, continue towards a subsequent section of the production line.

The machine 1 is set up with a gripping unit for the plate L, indicated—in its entirety—with the reference G. The gripping unit G comprises a group of gripping members 7 made in any known way. In a preferred example, each gripping member 7 is a suction cup member, which can be activated by vacuum.

The suction cup gripping members are completely conventional devices currently used in plate processing machines and for this reason they are not described in detail here. Typically, each suction cup member 7 has an upper suction cup intended to engage the lower face of a plate L so as to define an isolated chamber with respect to the external environment, which is placed in communication with a vacuum source in order to make the plate strongly adhere to the suction cup.

The gripping members 7 can also be made according to any known alternative technique, for example they can be in the form of clamp devices.

An important characteristic of the machine according to the invention lies in the fact that the gripping unit G is movable in the conveying longitudinal direction X of the plate L.

In the embodiment illustrated here, the gripping unit G is supported at its base by a carriage C (see for example FIGS. 10 and 10A), which is slidably mounted by means of shoes 8A (FIG. 10A) on longitudinal guides 8 of a beam B extending parallel to the conveying longitudinal direction X. The electronically-controlled actuator device that controls the movement of the carriage C along the beam B can be, for example, a servo-controlled electric motor 80 (FIG. 10A), carried by the carriage C, which rotates a pinion 81 engaging a stationary rack 82 extending in the X direction and fixed to the beam B.

FIG. 10A also shows the vertical rotation axis 9 of the unit G of the gripping members 7. The unit G has a base structure 70 rotatably mounted on the carriage C around the axis 9. The carriage C is also associated with a servo-controlled electric motor (not shown) which controls the rotation of the unit G around the vertical axis 9.

The base structure 70 of the unit G carries the gripping members 7 so as to allow adjustment of the position of the gripping members 7, individually or in units.

To this end, the gripping members 7 are carried, individually or in units, by members, which can be displaced with respect to the base structure by means of actuator devices of any known type, controlled by an electronic controller E. The configuration and arrangement of these mobile members carrying the gripping members 7 may be of any known type.

For example, FIG. 10A shows a solution in which the gripping members 7 are carried in units on slides 71 (only one of which is visible in the drawing) slidably mounted along horizontal directions orthogonal to each other. The movement of each slide is controlled, for example, by an electric servomotor (not shown) by means of a screw and nut screw transmission (not shown) according to a conventional technique in the field of machine tools. FIGS. 1, 2 schematically show an alternative solution, in which the gripping members 7 are carried by telescopic arms 10, which can also be oriented around the vertical axis 9 (see also FIGS. 12, 23, 24, 28).

In this way, whatever the configuration of the means for adjusting their position, the gripping members 7 may be automatically adjusted in position according to the shape and size of the plate to be processed, as will also be shown below with reference to the examples illustrated in the FIGS. 22-28.

Therefore, the gripping unit G reconfigures itself according to the shape and size of the plate to be gripped.

The electronic controller E is configured to arrange the gripping members 7, before starting a processing cycle, according to the shape and size of the plate to be gripped, in positions suitable for ensuring that the plate is stably maintained in a horizontal position above the carriage C during the processing of the plate.

Again with reference to FIG. 10A, each gripping member 7 is also vertically displaceable. In the example shown in FIG. 10A, each suction cup 7 is carried by a stem 7A movable vertically with respect to a respective base support 7B.

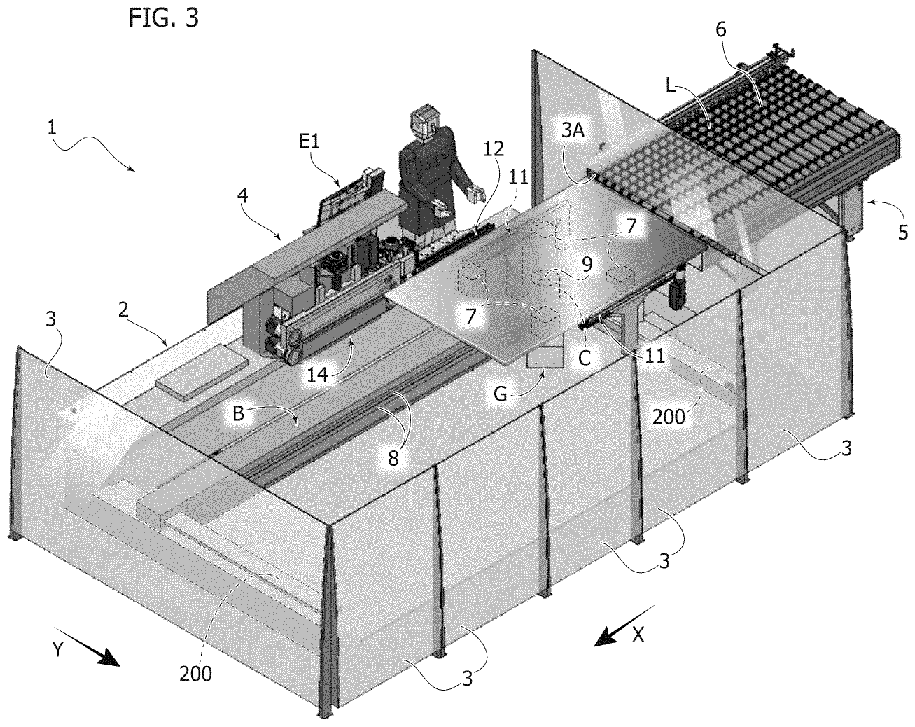

Returning to FIG. 1, and to the following FIGS. 2, 3, a plate L that enters the work area of the machine coming from the plate loading system on the machine is received on a plate transport device, which then carries the plate above the gripping members 7, to allow them to take the plate thereon, rising vertically.

In the example illustrated here, the transport device that receives the plate L entering the machine is defined by a pair of belt conveyors 11, the reciprocal distance of which is adjustable in the transverse direction by means of an actuator device according to the size of the plate. To this end, one of the two conveyors 11 is carried by a structure sliding transversely to the direction X on a side 200 of the fixed support structure of the machine (see for example FIGS. 9-11).

In the embodiment illustrated here, the belt conveyors 11 have the object of advancing the plate entering the machine up to a position in which it is located in a precise position with respect to the processing unit 4 along the longitudinal direction X and along a transverse direction Y.

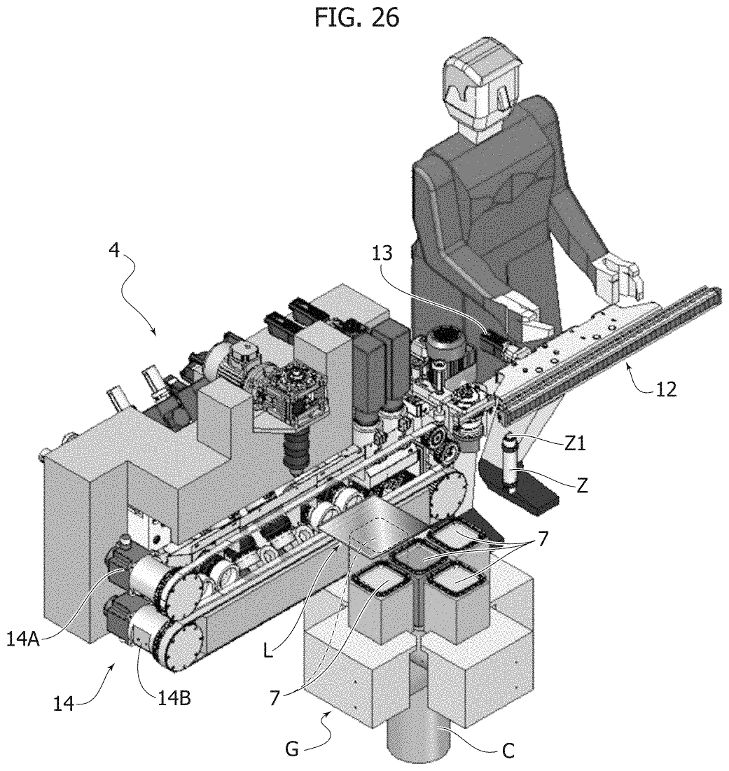

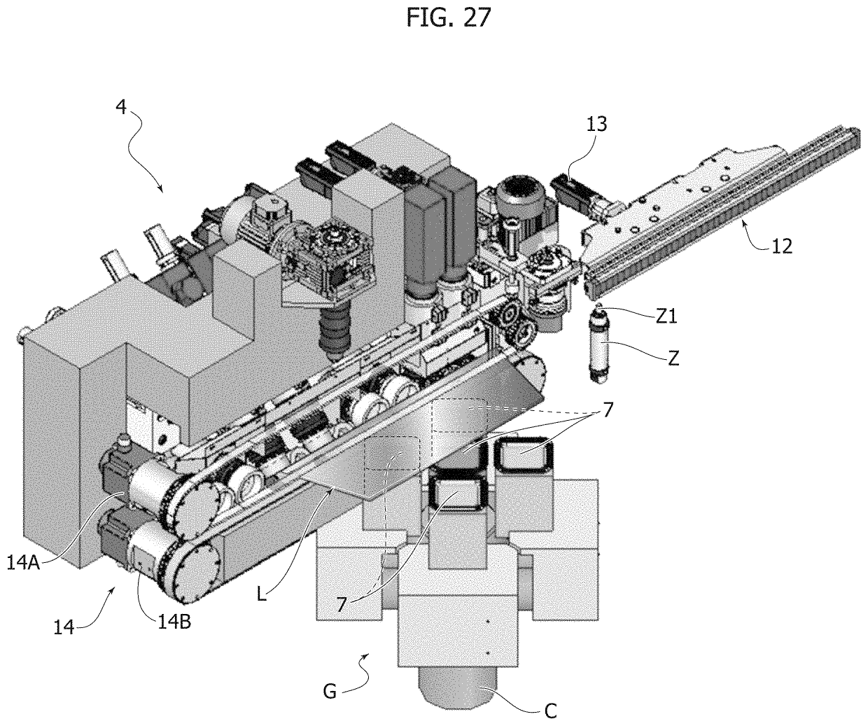

To this end, the machine comprises a disc device (indicated by Z in FIGS. 26 and 27), which can lift an abutment element Z1 into an operative position wherein it opposes the advancement of the plate. With the element Z1 in the raised position, the plate L entering the machine is advanced by the belt conveyors 11 until the front edge of the plate is in contact with the element Z1. In this condition, the plate is in a predetermined position with respect to the processing unit 4, along the longitudinal direction X. Furthermore, on one side of the stationary structure, the machine comprises a side support wall 12 (see, for example, FIG. 12) which can be moved in the transversal direction by means of an actuator 13 so as to push the plate L in the transverse direction Y, orthogonal to the longitudinal direction X, up to a predetermined position with respect to the tools of the unit 4, corresponding to a predetermined dimension of the working depth of the tools on the edge of the plate.

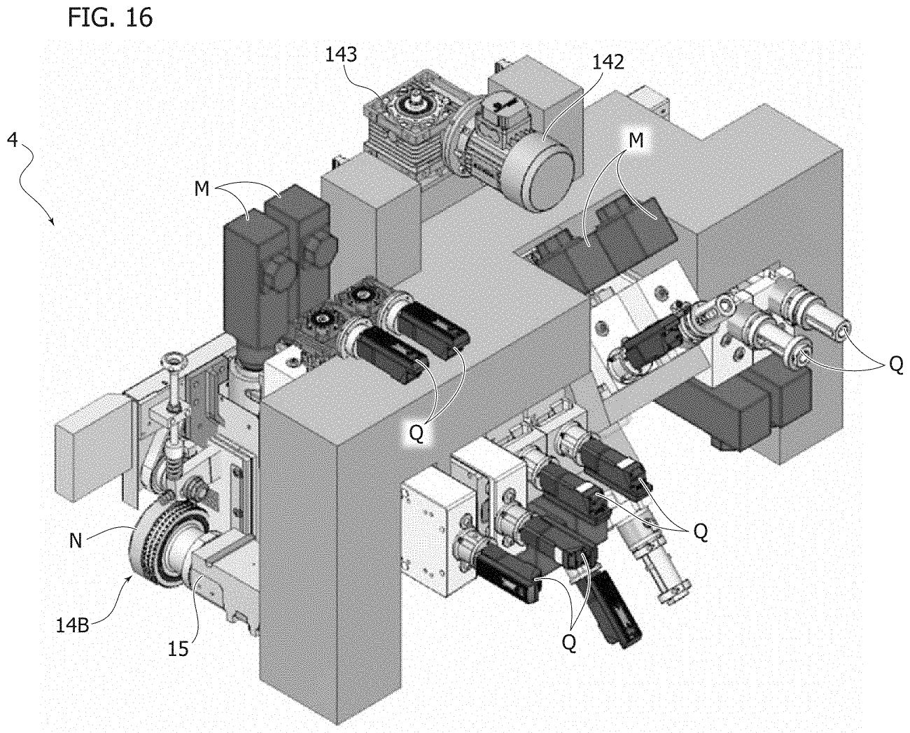

With reference to FIGS. 13A, 13B and 14-16, and in particular to FIG. 15, they illustrate, purely by way of example, a machining unit 4 including a series of grinding tools aligned in the conveying longitudinal direction X of the plate L, intended to engage in succession a lateral edge of the plate, in order to subject each portion of the edge of the plate to a plurality of grinding operations, with a progressively increasing degree of finish.

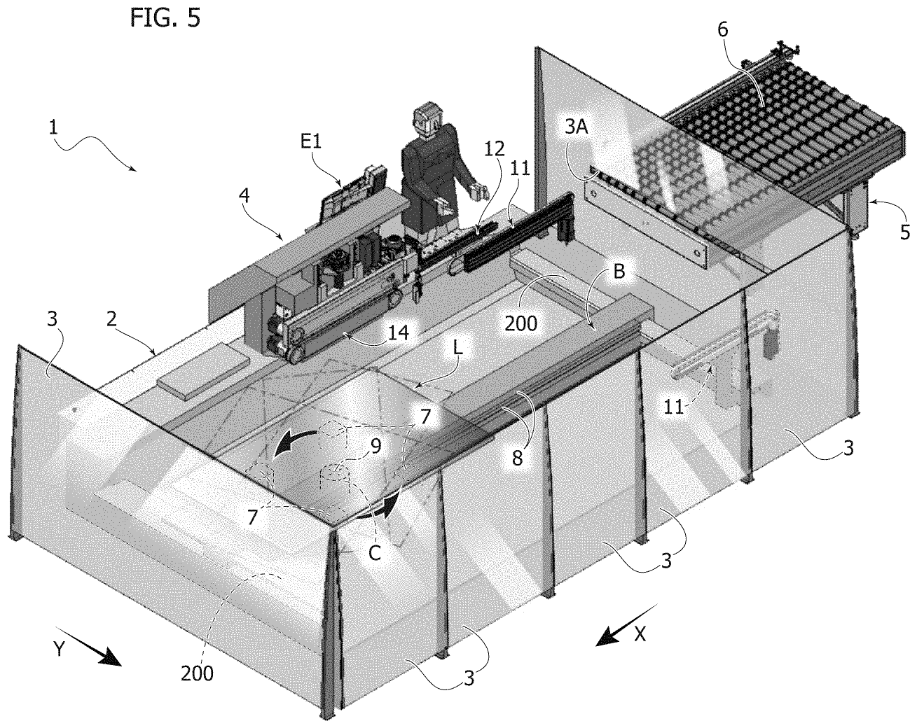

With reference in particular to FIG. 5, the plate L, advancing in the conveying longitudinal direction (from right to left in the Figure) first encounters a pair of roughing wheels 40 with a vertical axis, then a pair of cup wheels 41, with a substantially horizontal axis, then two further pairs of cup wheels 42, 43, with axes inclined both with respect to the vertical direction and with respect to the horizontal direction, for a beveling operation (when this is required), respectively, of the upper and lower edges of the lateral edge of the plate, and finally a further pair of cup wheels 44, with horizontal axis.

According to the conventional technique, motor units M (only some of which are visible in the drawings) are associated with the grinding wheels 40-44, each comprising an electric motor to drive each respective grinding wheel in rotation. Furthermore, again according to the conventional technique, the position of each cup wheel along its axis and the position of the wheels 40 both with respect to the vertical direction and with respect to a direction Y transverse to the longitudinal direction X are adjustable by means of actuator units Q (only some of which are visible in the drawings) each including an electric motor and a gearbox for controlling sliding slides carrying the tool-holder units with the relative motors.

These aspects are given here purely by way of example and are not further described in detail, since they can be made in any known way and as they do not fall, taken alone, within the scope of the present invention.

The possibility of adjusting the position of the various tools allows both selection of the tools required (for example, if a beveling operation is not required, the cup wheels 42, 43 are kept in an inoperative retracted position) and adjustment of the position of the tool according to the required working depth on the item.

With reference to FIG. 13A, a conveyor device 14 is associated with the machining unit 4 and is used to advance the plate L in the conveying longitudinal direction X so as to bring one of its lateral edges to engage the grinding tools in succession. The conveyor device 14 is composed of an upper belt conveyor 14A and a lower belt conveyor 14B superimposed on each other in such a way as to define parallel and facing branches between which the plate to be transported is engaged. The upper belt conveyor 14A and the lower belt conveyor 14B each comprise a belt N, preferably a toothed belt, engaged on wheels W, which are toothed wheels in the case of toothed belts. In each of the upper and lower belt conveyors 14A, 14B, one of the wheels W is driven by an electric motor 15.

The entire support structure of the upper conveyor 14A is carried by a support 140 which is slidably mounted vertically on guides 140A with respect to the stationary structure of the machine. The vertical position of the upper conveyor 14A is selected according to the thickness of the plate L to be processed. To this end, the support 140 carries a nut screw engaged by a screw 141 rotated by a motor-gearbox 143 through a transmission 142.

The upper branch of the lower belt N slides on a horizontal support surface 16 of the support structure of the conveyor device, while the lower branch of the upper belt is held against the plate by a plurality of stationary shoes P, carried by the support structure and configured to keep the lower branch of the upper belt in contact with the plate in order to maintain a constant thrust pressure coming from the upper transport branch 14A on the portion which is between the toothed profile wheels.

Once again, both the configuration of the stationary machining assembly 4, comprising the aligned series of grinding tools 40-44, and the configuration of the conveyor device 14 can vary widely with respect to the examples illustrated here.

In particular, the nature and arrangement of the grinding tools may vary, depending on the machining requirements, as well as the construction details relating to the systems for actuating the rotation of the grinding tools and the movements for adjusting the position of these tools.

Returning to FIG. 1, in the specific illustrated example, the ends of the longitudinal beam B slide on sides 200 of the stationary structure 2 of the machine. Similarly to the movement of the carriage C and along the beam B, the movement of the beam B along the sides 200, in a horizontal direction Y transverse to the longitudinal direction X, can also be controlled by an electric actuator of any type known in the field, specifically by a servo-controlled electric motor, or by a pair of servo-controlled electric motors arranged on the two sides 200 of the machine, which activate the movement of the beam B by means of transmission systems of any known type (for example screw and nut screw). Again, these construction details are not illustrated here, both because they can be made in any known way, and because their elimination from the drawings makes the latter simpler and easier to understand.

Once the plate L has been loaded at the entrance to the machine, it is located in position, as illustrated above, both with respect to the longitudinal direction X and with respect to the transverse direction Y. Once this operation has been carried out, the plate is deposited on the gripping members 7 of the gripping unit G, and the gripping members 7 are activated, so as to stably grip the plate L in the aforesaid predetermined position with respect to the X and Y directions. In this condition, the members 7 refer the plate in position with respect to the vertical direction.

Once this operation has been carried out, the carriage C carrying the gripping unit G is made to advance in the conveying longitudinal direction X, in such a way that a lateral edge of the plate L engages the conveyor device 14 associated with the unit 4 of grinding tools. As already indicated above, the further advancement of the plate causes each portion of the lateral edge of the plate to subsequently engage the different tools of the machining unit 4.

The electronic controller E of the machine, with which a man-machine interface El is associated (FIG. 1) is thus able to receive information on the position of the plate along X and along Y, and can consequently adjust the position of the grinding tools depending on the type of machining required (for example, excluding tools that are not requested) and depending on the required working depth. Advancement of the plate L along the machining unit 4 is determined by the conveyor device 14. The electronic controller, therefore, regulates the transport speed of the conveyor device 14 as a function of the processing parameters set by the user through the interface E1. At the same time, the electronic controller controls the advancement of the carriage C carrying the gripping unit G in synchronism with the advancement of the plate L determined by the conveyor device 14.The position of the gripping unit G, and consequently the position of the plate L, along the longitudinal direction X is constantly known to the electronic controller.

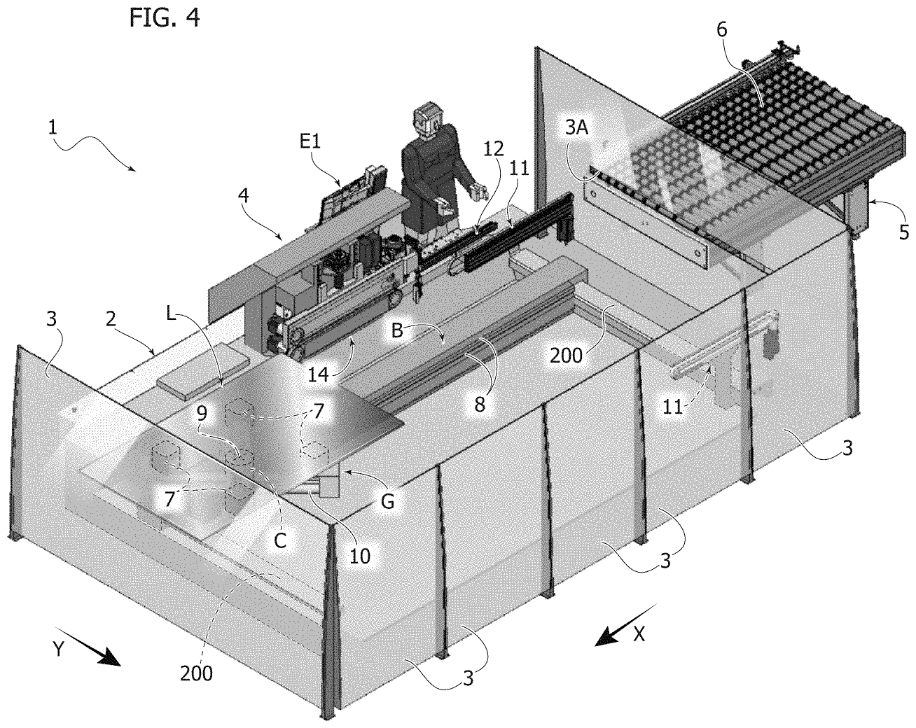

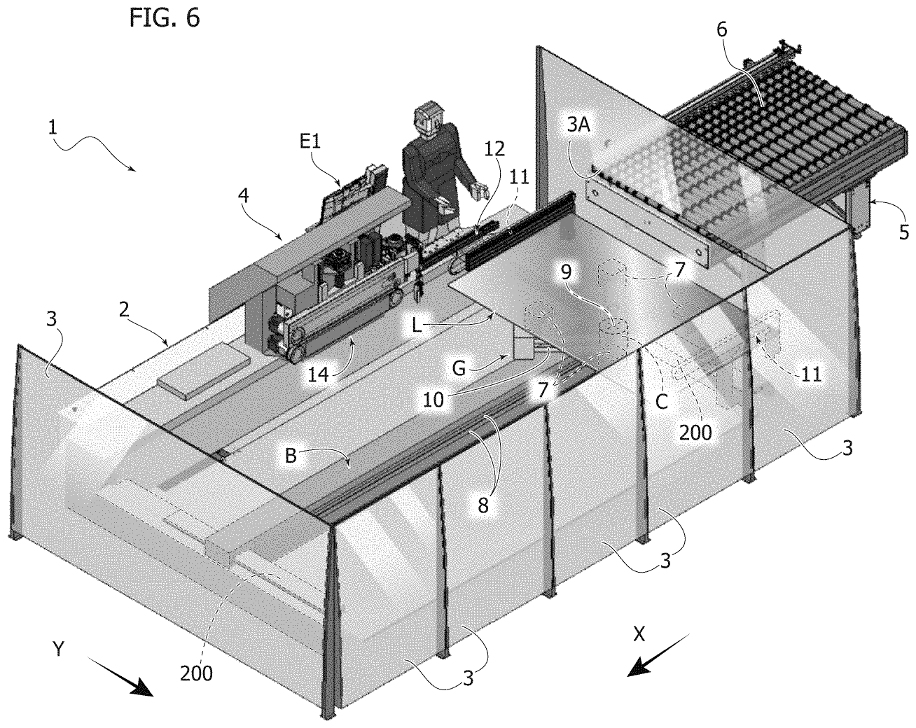

Returning to FIGS. 1-7 and to the example of the processing cycle illustrated therein, FIG. 1 illustrates the plate L before it enters the machine, FIG. 2 illustrates the plate L during the loading step into the machine, FIG. 3 illustrates a subsequent step wherein the plate L has already been located in position, locked by means of the gripping unit G, and then made to advance by the conveyor device 14 and the carriage C carrying the gripping unit G along the processing unit 4, in such a way as to machine a lateral edge of the plate which is engaged in succession by the grinding tools of the machining unit 4. FIG. 4 shows the plate at the end of the machining of its first edge, when the rear edge (with reference to the feed direction X) of the plate has also left the engagement with the grinding tools. Starting from this position, the beam B is moved in the Y direction by the electronic controller up to a position (FIG. 5) wherein the plate L can be rotated around a vertical axis (controlling a rotation of the entire gripping unit G) without interfering with the machining unit 4. In the example shown, the plate is rotated by 90°, to allow the subsequent processing of a further edge of the plate, contiguous to the edge that has already been machined. After being rotated, the plate is brought back to a starting position at the entrance to the machine by means of a return movement of the carriage C carrying the gripping unit G along the beam B. Once the position illustrated in FIG. 6 has been reached, the plate is brought back to the side of the machine carrying the machining unit 4 by means of a movement of the beam B in the Y direction.

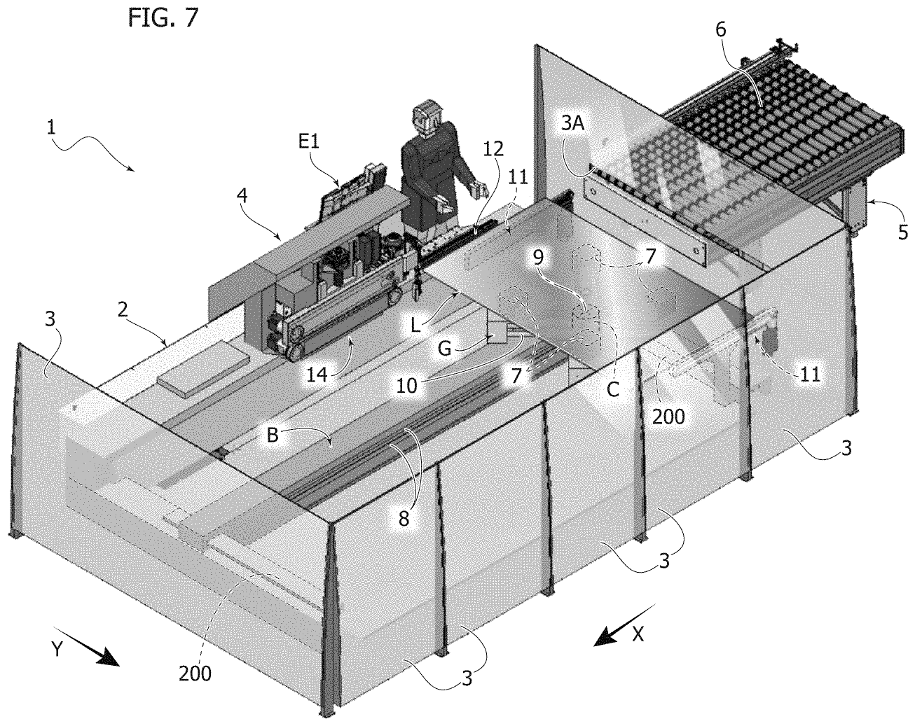

It is important to underline that, in this step, it is not necessary to repeat the operations of positioning of the plate, since after the operation carried out at the beginning of the cycle of operations, the plate always remains firmly anchored to the gripping unit G, so that the electronic controller knows precisely the position and orientation of the plate at all times, and is therefore able to control the movement of the carriage C and the beam B in order to bring the plate back exactly to a required starting position. Starting from the position reached in FIG. 7, the cycle can be repeated by making the plate L advance again by means of the conveyor device 14 of the machining unit 4 and by means of the carriage C carrying the gripping unit G, so as to subject a second edge of the plate to processing. At the end of the processing of each edge, the operations described above can be repeated, until the processing of all the edges of the plate is completed, if required.

It is important to note that an advantage of the arrangement described above lies in the fact that the electronic controller can orient the plate to ensure that with the subsequent processing of the edges not only a required finishing processing of the edges is obtained, with possible bevel processing, but also a squaring of the plate, and/or its shaping is carried out, according to a required configuration, with the possibility of returning, if necessary, the plate to nominal project dimensions, eliminating any irregularities in shape deriving from defects in the processing to which the plate has been subjected previously.

Again with reference to the embodiment illustrated in FIGS. 1-7, it should be emphasized that the embodiment is provided here purely by way of example. In particular, the configuration of the elements of the machine that allow the gripping unit G to be moved both in the longitudinal direction X, and in the transverse direction Y, can widely vary with respect to what has been described. For example, the carriage C carrying the gripping unit G could be slidably mounted in the transverse direction Y on a beam oriented parallel to the Y direction and slidably mounted on the stationary structure of the machine in the longitudinal direction X.

The machine according to the invention is also suitable for use in line, providing a plate inlet upstream of the machine and a plate outlet downstream of the machine (for example, with a table 50 having a roller plane 60—FIG. 8) or it can be used as a stand-alone machine, in which case it could also be possible to provide a plate outlet at the same upstream end of the machine (see FIG. 9), for example, with a table 50 for unloading the plate, side by side to the table 5 that receives the plate entering the machine, and having a roller plane 60. Again, these details are just an example, since the machine can be equipped with any type of device for loading and unloading the plate in a manual or automatic mode.

Auxiliary machining devices can be associated with the machining unit 4, to carry out further machining of the plate, upstream or downstream of the grinding tools 40-44.

For example, with reference to FIGS. 17, 18, a grinding wheel 16 rotating around a vertical axis, driven by an electric motor 16A to perform a chamfer at a corner of the plate, can be provided at the inlet of the machining unit 4. FIG. 18 illustrates—on an enlarged scale—the detail of the grinding wheel 16 during machining. It must be considered that the thicknesses of material indicated with 17 in FIG. 18 are intended to be removed by the subsequent processing of the edges of the plate. Therefore, the residual portion of the chamfer performed by the grinding wheel 16 has a width 1i less than the width 12 of the chamfer obtained at the beginning of the machining. The diameter of the grinding wheel 16 is chosen in such a way that the residual portion of chamfer, having a width I₁, approximates a flat surface.

With reference to FIG. 17, the reference numbers 18 indicate freely rotatable, wheels which are pushed against the plate by two pneumatic or electric actuators 19 in order to limit or completely eliminate any vibrations of the plate L during processing.

FIGS. 19-21 illustrate an example of a so-called “radiusing” device, arranged downstream of the machining unit 4, intended to operate as an alternative to the chamfering device constituted by the grinding wheel 16, to impart a curved profile to a vertex of the plate, or rather “rounded”.

Also in this case, freely rotatable wheels 20 are provided, pushed by respective electric actuators 21 against the upper face of the plate, to limit or completely eliminate any vibrations of the plate L during processing. In this case, the lower face of the plate instead rests on a longitudinally aligned series of freely rotatable rollers 22, carried by the support structure of the machining unit.

With reference in particular to FIGS. 20, 21, the radiusing device R is preferably made in accordance with the disclosure of European patent EP 3 012 066 B1 by the same Applicant. According to this solution, a grinding wheel 23 rotating around a vertical axis is carried by an apparatus that includes a base plate, which is moved in the conveying longitudinal direction X in synchronism with the advancement of the plate L, and electronically-controlled actuators to move the grinding wheel, during its rotation, both in the X direction and in the Y direction with respect to said base plate. In this way, the device is capable of imparting any required curved profile to a vertex of the plate, during advancement of the plate. FIG. 20 shows the grinding wheel 23 during processing, while FIG. 21 shows the grinding wheel 23 after completion of the processing, when the plate L has already advanced further (the rounded corner V is visible).

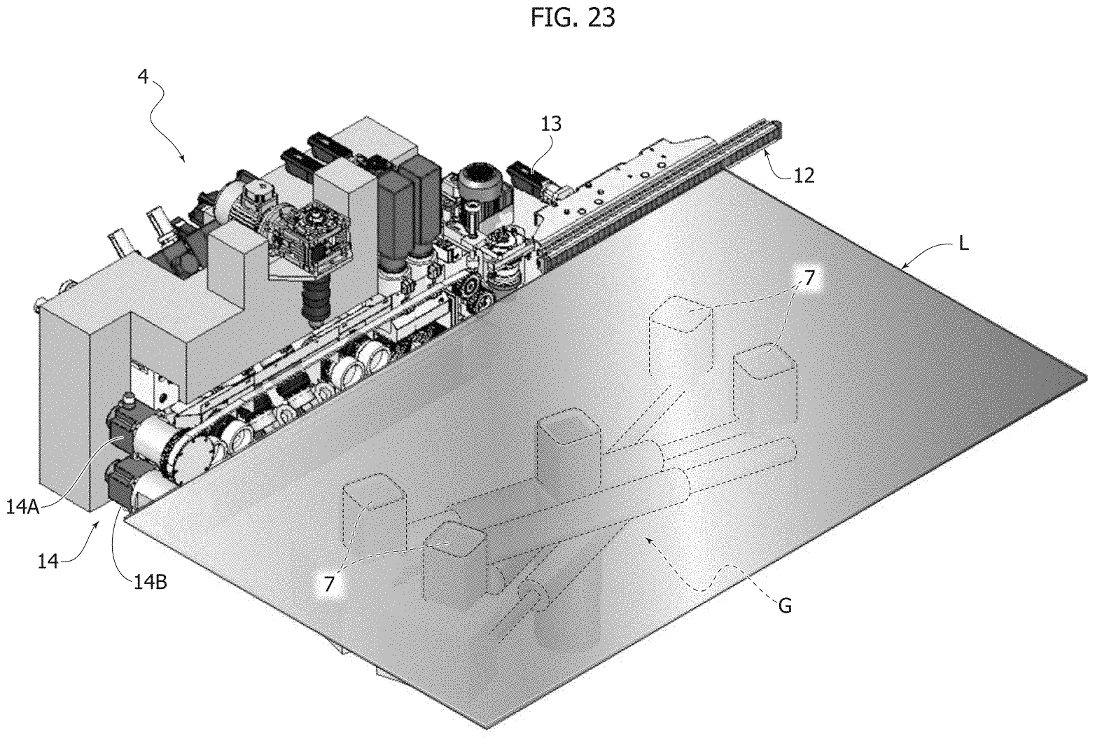

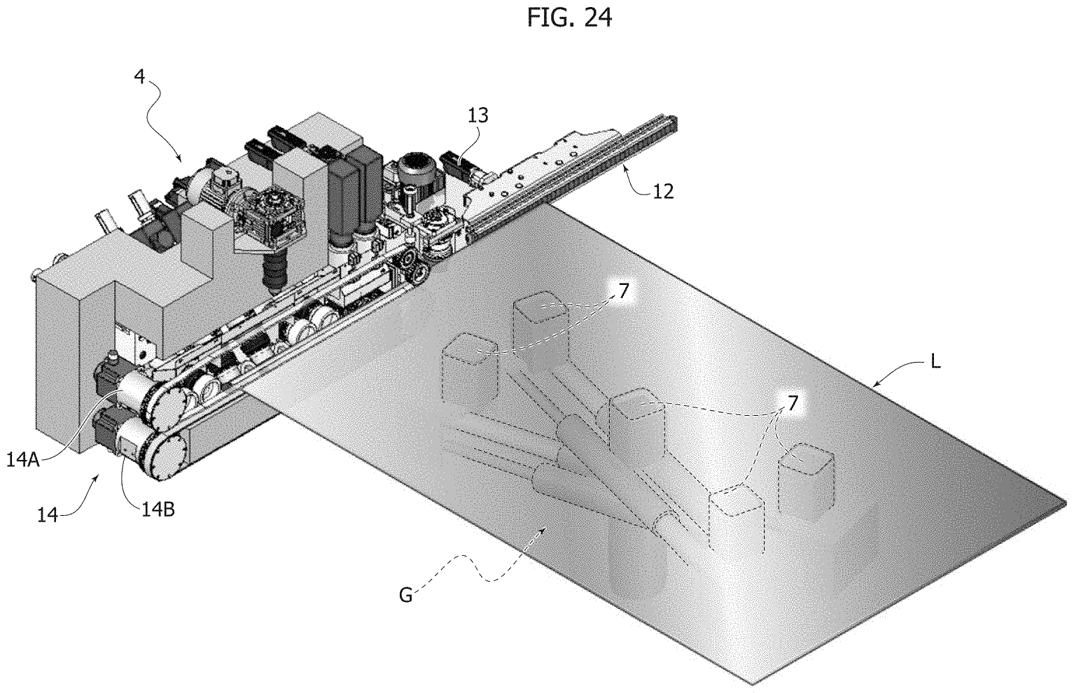

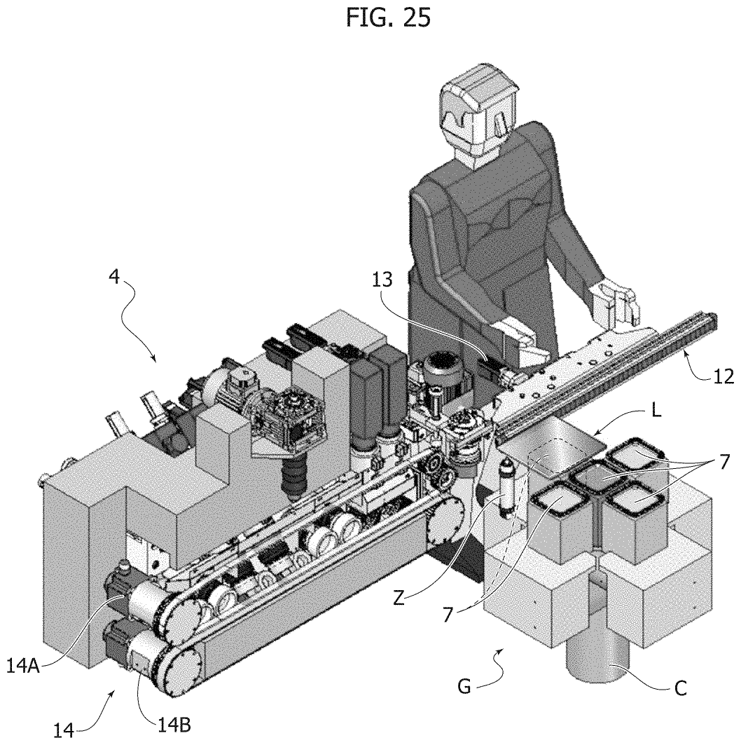

As already discussed above, one of the advantages of the machine according to the invention lies in the fact that the gripping unit G of the plate can be reconfigured in a completely automatic way, depending on the size and shape of the plate. FIGS. 22-28 show different examples of use of the machine according to the invention with different plate shapes and sizes. FIG. 22 shows the application to a square-shaped plate of relatively small dimensions, which requires arranging the gripping members 7 in the position of maximum mutual proximity. FIGS. 23, 24 show two successive steps of the manufacturing cycle of a large rectangular plate. FIG. 23 shows an operation step wherein the machine is processing a long side of the plate, while FIG. 24 shows the operation step of the machine during processing of a short side of the plate. FIG. 25 shows the use of the machine with an extremely small square item, which can be loaded manually by an operator using only one of the gripping members 7. FIG. 26 shows the step in which the item is brought to the machining unit.

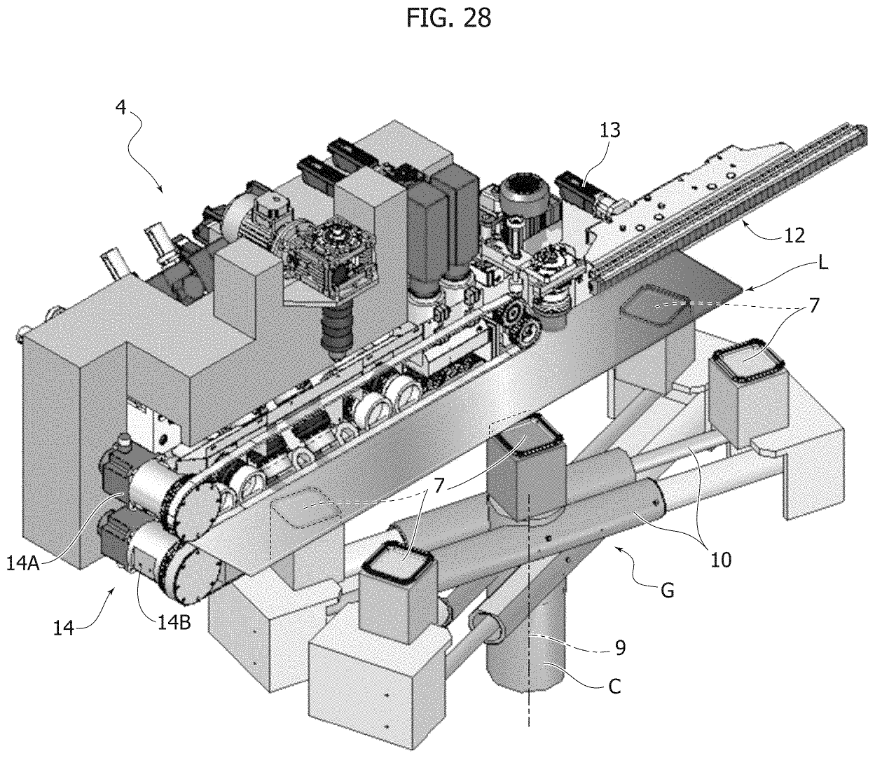

FIGS. 27, 28 show examples of application on long plates with a reduced transverse dimension, which can be locked on the gripping unit G using only two of the gripping members 7.

In general, the fully automatic operating mode which has been described with reference to FIGS. 1-7 is possible with relatively large plates. For relatively small dimensions it is necessary to use semi-automatic and manual modes. In the case of semi-automatic modes, the operator, in addition to positioning the item at the beginning of the processing cycle, will have to rotate the item only once during the execution of the lateral edges of the plate, while for the manual mode, the operator will have to rotate the plate for all the edges to be processed, without moving from the loading station.

FIGS. 29, 30 are plan views of further variants of the machine which refer to examples of implementations of the machine aimed at allowing the processing of several plates (in the example two plates L1, L2) immediately one after the other. To this end, the machine may be provided with two gripping units G1, G2 associated with two respective carriages C1, C2. In the example of FIG. 29, each of the carriages C1, C2 is carried by a carriage movable in the Y direction on guides 30 which are—in turn—movable in the X direction on guides 31.

FIG. 30 illustrates a variant wherein the two gripping systems G1 and G2 are carried by respective carriages C1, C2 slidably mounted on opposite sides of a common transverse beam T which is—in turn—slidably mounted in the X direction on a longitudinal beam B of the machine.

As will be understood, these solutions are only some examples of the embodiments of the invention. With solutions of the type illustrated in FIGS. 29, 30, it is possible to process two plates one immediately after the other. Of course, the systems can also be modified according to the needs of each specific application. Theoretically, it would also be possible to provide more than two gripping units G moving independently of each other (as in FIG. 29), or moving only partially independently of each other, as in FIG. 30, in order to perform the processing of three or more plates in rapid succession.

Of course, without prejudice to the principle of the invention, the details of construction and the embodiments may vary widely with respect to those described and illustrated purely by way of example, without departing from the scope of the present invention, as defined by the attached claims.

For example, the gripping members 7, in the specific case illustrated—the gripping suction cups—may, if necessary, be made with specific shapes depending on the product to be processed and/or with different sizes and shapes.

The carriage carrying the gripping unit G may be equipped with abutment members that are automatically activated on the side(s) opposite to the processing side to counteract forces exerted by the tools during processing,

One of the gripping members may be equipped with abutment members and adjusters to allow automatically positioning and centering in the case of processing of plates of relatively reduced dimensions,

Downstream and/or upstream of the unit 4 of the machining tools, auxiliary units can be positioned, on one or more sides of the product, for cutting (with different angles).

Downstream and/or upstream of unit 4 of the machining tools, auxiliary units can be positioned for surface processing (such as removal of the coating for glass, removal of mesh for ceramic products, cleaning and/or bush hammering for natural stones, synthetics and ceramics).

1. A machine for processing lateral edges of glass plates, plates of stone material or plates of synthetic material, the machine comprising:
a stationary support structure,
a group of plate gripping members, configured to hold a plate in a horizontal position during a plate processing,
wherein the group of plate gripping members is carried by a carriage movable at least in a plate conveying longitudinal direction,
a stationary machining unit (4) for machining a lateral edge of the plate, the unit being carried by said stationary supporting structure and including a series of grinding tools aligned along the conveying longitudinal direction, in such a way as to engage in succession a lateral edge of a plate that advances along said conveying longitudinal direction,
wherein with said carriage carrying the group of plate gripping members, an electronically-controlled actuator device is associated, configured to move the carriage along said conveying longitudinal direction,
the plate gripping members adjustable in position with respect to the carriage, and relative to each other by means of electronically-controlled actuator devices, and an electronic controller configured to adjust the position of the gripping members before processing the plate, as a function of the size and/or shape of the plate, so as to arrange the gripping members so as to ensure that the plate is firmly locked in a horizontal position on the carriage during processing of the plate.

2. A machine according to claim 1, wherein the group of plate gripping members is rotatably supported by the carriage around a vertical axis, and is configured to be oriented around this vertical axis by means of an electronically-controlled actuator device,
in such a way that after processing of a lateral edge of a plate, the plate can be brought to a position out of interference with the grinding tools of the stationary machining unit, and can then be rotated around said vertical axis and returned to a starting position with respect to the stationary machining unit, for subsequent processing of another lateral edge of the plate by means of said grinding tools of the stationary machining unit.

3. A machine according to claim 2, wherein the carriage carrying the plate gripping members can also be moved by an electronically-controlled actuator device in a transverse horizontal direction, orthogonal to said conveying longitudinal direction, so that after processing of a lateral edge of the plate, the plate can be moved transversely with respect to the conveying longitudinal direction to a position in which the plate can be rotated around said vertical axis without interfering with said stationary machining unit, after which the plate can be brought back to said starting position to start processing of another edge of the plate.

4. A machine according to claim 3, wherein said carriage carrying the unit of plate gripping members is movable in the conveying longitudinal direction along a longitudinal beam, which has opposite ends slidably mounted on the stationary structure of the machine in said transverse direction, orthogonal to the longitudinal direction of the beam.

5. A machine according to claim 1, a conveyor device is associated with said stationary machining unit to advance a plate along said conveying longitudinal direction, so that a lateral edge of the plate engages the grinding tools of said stationary machining unit in succession, said device for actuating the longitudinal movement of the carriage carrying the group of plate gripping members being controlled in such a way as to move the group of plate gripping members in synchronism with said conveyor device.

6. A machine according to claim 5, wherein the conveyor device comprises an upper belt conveyor and and a lower belt conveyor positioned and configured to receive a plate therebetween in such a way as to advance the plate in the conveying longitudinal direction.

7. A machine according to claim 1, wherein the carriage carries the plate gripping members, individually or in groups, in positions that are adjustable in a horizontal direction by means of electronically-controlled actuator devices.

8. A machine according to claim 7, wherein each gripping member can be moved vertically.

9. A machine according to claim 1, further comprising a plate positioning system, for locating the plate in position with respect to the stationary machining unit along the longitudinal direction and along the transverse direction, at the beginning of a machining cycle, before locking the plate on said group of plate gripping members, the gripping members then locating the plate in position with respect to the vertical direction, and
in that after processing of a first lateral edge of the plate, the group of gripping members is always kept engaged on the plate until processing of all the lateral edges of the plate that are to be machined has been completed, so that the operation for locating the plate in position does not have to be repeated before processing another lateral edge of the plate.

10. A machine according to claim 9, wherein said plate positioning system comprises an abutment element, which can be temporarily positioned in a raised position in which it can be engaged by a front edge of a plate to be machined, so as to locate the plate in position with respect to the conveying longitudinal direction.

11. A machine according to claim 10, wherein the plate positioning system further comprises a side wall for abutment against the plate, which can be moved by an actuator device in the transverse direction orthogonal to said conveying longitudinal direction, to transversely push a plate to be machined up to a predetermined transverse position with respect to the grinding tools of said stationary machining unit.

12. A machine according to claim 1, further comprising a plate loading section with a plate conveying system, configured to receive a plate to be machined and to bring it above the group of plate gripping members.

13. A machine according to claim 1, wherein upstream and/or downstream of said series of grinding tools, a chamfering device and/or a radiusing device are provided to make a chamfer and/or a curved profile on a corner of the plate.

14. A machine according to claim 1, further comprising two or more carriages carrying respective units of gripping members to grip respective plates to be machined, each carriage being displaceable both in said conveying longitudinal direction and in said transverse direction orthogonal to the conveying longitudinal direction, by means of respective electronically-controlled actuator devices.

15. A machine according to claim 1, further comprising one or more of the following further characteristics:
the gripping members having shapes selected according to the shape and size of the plate to be machined and/or have different sizes or shapes from each other,
the carriage carrying the group of gripping members i-.s--equipped with abutment members that are automatically activated on the side(s) opposite to the processing side to counteract forces exerted by the tools during processing,
one of the gripping members equipped with abutment members for automatically positioning and centering plates of relatively reduced dimensions,
downstream and/or upstream of the stationary machining unit auxiliary units positioned to perform a cutting operation, at different angles, on one or more sides of the plate,
downstream and/or upstream of the stationary machining unit, auxiliary units positioned for surface machining of the plate.

16. A method for processing lateral edges of glass plates, plates of stone material or plates of synthetic material, comprising:
providing a group of plate gripping members, configured to hold a plate in a horizontal position during processing of the plate,
advancing said group of plate gripping members in a conveying longitudinal direction of the plate, in such a way as to bring a lateral edge of the plate to engage in succession a series of grinding tools forming part of a stationary machining unit, and aligned in said conveying longitudinal direction of the plate,
wherein said plate gripping members are carried by a carriage movable in said conveying longitudinal direction, in such a way that the gripping members are adjustable in position, by means of electronically-controlled actuator devices, with respect to the carriage and relative to each other, and
in that before the start of a plate processing cycle, said plate gripping members are adjusted in position by said electronically-controlled actuator devices as a function of the size and/or shape of the plate, so as to arrange the gripping members in such positions as to ensure that the plate is firmly locked in a horizontal position on the carriage during during processing of the plate.

17. A method according to claim 16, wherein said carriage carrying the group of plate gripping members rotatably supports said group around a vertical axis, and is provided with an electronically-controlled actuator device for controlling the rotation of said group around said vertical axis, and wherein after processing of a lateral edge of a plate the plate is brought to a position out of interference with the grinding tools of the stationary machining unit, and is rotated around said vertical axis to be then brought back to a starting position for subsequent processing of another edge of the plate by said grinding tools of the stationary machining unit.

18. A method according to claim 17, wherein the carriage carrying the group of plate gripping members can also be moved by an electronically-controlled actuator device in a horizontal transversal direction, orthogonal to said conveying longitudinal direction and wherein after processing a lateral edge of the plate, the plate is displaced in the transverse direction orthogonal to the conveying longitudinal direction to a position wherein it is rotated around said vertical axis without interfering with said stationary unit of tools, after which the plate is brought back to said starting position to start the processing of another edge of the plate.

19. A method according to claim 16, wherein a conveyor device is associated with the stationary machining unit said conveyor device advances a plate along the plate conveying longitudinal direction in such a way that a lateral edge of the plate engages in succession the grinding tools of said stationary machining unit, while the device for actuating the longitudinal movement of the group of plate gripping members is controlled in such a way as to move the group of gripping members in synchronism with said conveyor device.

20. A method according to claim 16, wherein the beginning of a machining cycle of a plate the plate is located in position relative to the stationary machining unit along the longitudinal direction and along the transversal direction, after which the plate is gripped by said group of plate gripping members, which locate the plate in position with respect to the vertical direction, and
in that the plate, after processing of a first lateral edge of the plate, always remains engaged by said group of gripping members until the processing of all the lateral edges of the plate that are to be machined is completed, so that the operation for locating the plate in position does not have to be repeated before processing another lateral edge of the plate.

21. A method according to claim 16, wherein before or after the grinding of a lateral edge of the plate, at least one corner of the plate is subjected to a process to form a chamfer or a curved profile at the corner.

22. A method according to claim 16, wherein two or more carriages are arranged, carrying respective groups of plate gripping members, which receive respective plates that are caused to advance one after the other with respect to said stationary machining unit-04 to process a lateral edge of each plate.
